(19) United States
(12) Patent Application Publication
(10) Pub. No.: US 2025/0173566 A1
(43) Pub. Date: May 29, 2025

(54) METHODS AND SYSTEMS FOR LEARNING REPRESENTATIONS FOR NODES OF A TEMPORAL BIPARTITE GRAPH

(71) Applicant: Mastercard International Incorporated, Purchase, NY (US)

(72) Inventors: Pritam Kumar Nath, Kolkata (IN); Govind Vitthal Waghmare, Pune (IN); Nikhil Tumbde, Nagpur (IN); Nitish Kumar, Jamshedpur (IN); Siddhartha Asthana, New Delhi (IN)

(21) Appl. No.: 18/953,677

(22) Filed: Nov. 20, 2024

(30) Foreign Application Priority Data
Nov. 25, 2023 (IN) 202341080166

(51) Int. Cl. G06N 3/08; G06N 3/042; G06N 3/049; G06Q 20/34

(52) U.S. Cl. CPC G06N 3/08; G06N 3/042; G06N 3/049; G06Q 20/34

(57) ABSTRACT

Methods and systems for learning representations for nodes of temporal bipartite graph. Method performed by server system includes accessing temporal bipartite graph including first nodes, and second nodes. Each first node has first features and each second node has second features. Method includes generating, by Graph Neural Network (GNN) model, first interim representations for each first node based on first features corresponding to each of a set of temporal two-hop neighbor nodes of each first node. Method includes computing first homogeneous representation for each first node based on first interim representations and first features of each first node. Method includes computing first global homogeneous representation for each first node based on first homogeneous representation for each first node. Method includes computing first local heterogeneous representation for each first node based on first homogeneous representation for each first node.

### TECHNICAL FIELD

The present disclosure relates to artificial intelligence-based processing systems and, more particularly, to electronic methods and complex processing systems for processing a temporal bipartite graph using Artificial Intelligence (AI) or Machine Learning (ML) models to learn representations for each node of the temporal bipartite graph.

### BACKGROUND

In the Artificial Intelligence (AI) or Machine Learning (ML) domain, a dataset can often be converted to temporal bipartite graphs or dynamic bipartite graphs such that they can be analyzed to learn insights from the dataset. These temporal bipartite graphs are used to perform various tasks, such as link prediction, node classification, recommendation generation, and the like. The terms ‘temporal bipartite graphs’ or ‘dynamic bipartite graphs’ refer to a type of graphical structure that represents a relationship between two distinct types of nodes over time. Several industries, such as the digital payment industry (e.g., credit card transactions), and the social media industry (e.g., webpages of popular websites) deal with data that can be represented as time-evolving dynamic bipartite graphs. For instance, in the digital payment industry, the temporal bipartite graph models the interactions between users (or cardholders) and merchants. Similarly, in an instance of the social media industry, temporal bipartite graphs can model interactions between users and webpages or posts on a website. Such temporal bipartite graphs have certain properties that are different from homogeneous graphs, e.g., features associated with the two distinct node types are different and may not lie in the same vector space. The term ‘heterogeneous graph’ refers to graph structures that represent a relationship between two different nodes of the same type.

Graph neural network (GNN) models have become increasingly popular in learning from graphs. Through message passing, aggregation, and self-attention, GNN models can model the graph structure and complex relations between nodes. Several GNN architectures have been developed in both heterogeneous and homogeneous graph domains. Owing to the ubiquitous nature of bipartite graphs, conventionally various techniques have been developed to learn from such graphs. For instance, some techniques focus on modeling static bipartite graphs without considering any information about temporal dynamics.

These GNN models are often not tailored for temporal bipartite graphs and fail to model the structural characteristics of bipartite graphs by overlooking the dynamic nature of the bipartite graphs. To address this, specialized GNN models have been developed to learn dynamic graphs. Conventional dynamic graph representation learning is deeply rooted in static graph representation learning, with a stronger focus on the evolving features of the graph and how its structure changes over time.

Some techniques have also been developed specifically for learning from dynamic graphs. For instance, some techniques focus on dynamic homogeneous graphs while being effective in modeling temporal dynamics for such graphs. However, since each node-set in a temporal bipartite graph has its unique characteristics if the bipartite graph is treated as a normal homogeneous graph, as done in the conventional techniques, the identity of each node-set might be lost, leading to poor learning by the AI/ML model. In particular, adding raw features of each node-set to learn node embeddings can lead to generalized node features across the graph, leading to feature contamination or corruption. Moreover, as the immediate neighbors in a bipartite graph belong to separate node classes, their feature spaces may not be aligned with each other. Therefore, aggregation of these features may degrade the quality of the node embeddings. This demands the need for a separate method for modeling dynamic bipartite graphs. Some conventional techniques try to model evolving bipartite graphs through dynamic representation as well by employing sinusoidal encoding of time to capture the temporal dynamics of the graph. However, the node representation learned using such techniques is not efficient.

Further, various conventional algorithms have tried to incorporate the temporal dynamics of the graph. Some algorithms discretely capture the changing graph using a series of snapshots. Since such algorithms perform a lossy transition of discretization of the time domain, these models cannot capture the graph's fine-grained evolution. In contrast, other conventional models use a self-attention mechanism based on temporal neighborhood and incorporate a functional embedding of time based on Bochner's theorem. In some instances, the GNN framework has been adopted to store the most recent node embeddings based on either node-wise or edge-wise events. However, such models do not capture the long-range dependencies of nodes in a temporally evolving bipartite graph.

Thus, there exists a technological need for technical solutions to learn representations for each node of the temporal bipartite graph that are free from the entanglement issue while capturing long-term dependencies such that the learned representations show high efficacy when used to perform different downstream tasks.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some example embodiments of the present disclosure;

FIG. 2 illustrates a simplified block diagram of a server system, in accordance with an embodiment of the present disclosure;

FIG. 3 illustrates an exemplary representation of a financial transaction dataset (also, called historical transaction data), in accordance with an embodiment of the present disclosure;

FIG. 4 illustrates an architecture of a Graphical Neural Network (GNN) model, in accordance with an embodiment of the present disclosure;

FIG. 5A, FIG. 5B, FIG. 5C, FIG. 5D, FIG. 5E, and FIG. 5F, collectively, illustrate the various intermediate processes performed by a machine learning model, such as the GNN model, in accordance with various embodiments of the present disclosure;

FIG. 6 illustrates experimental results of various experiments performed to determine the performance of the GNN model, in accordance with one or more embodiments of the present disclosure;

FIG. 7A, FIG. 7B, and FIG. 7C, collectively, illustrate a process flow diagram depicting a method for determining representations for each node of a temporal bipartite graph and performing a link prediction task, in accordance with an embodiment of the present disclosure;

FIG. 8 illustrates a simplified block diagram of an acquirer server, in accordance with an embodiment of the present disclosure;

FIG. 9 illustrates a simplified block diagram of an issuer server, in accordance with an embodiment of the present disclosure;

FIG. 10 illustrates a simplified block diagram of a payment server, in accordance with an embodiment of the present disclosure; and

FIG. 11 illustrates a process flow diagram depicting a method for determining representations for a first node of a temporal bipartite graph, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The terms “account holder”, “user”, “cardholder”, “consumer, “buyer”, and “customer” are used interchangeably throughout the description and refer to a person who has a payment account or a payment card (e.g., credit card, debit card, etc.) associated with the payment account, that will be used by a merchant to perform a payment transaction. The payment account may be opened via an issuing bank or an issuer server.

The term “merchant”, used throughout the description generally refers to a seller, a retailer, a purchase location, an organization, or any other entity that is in the business of selling goods or providing services, and it can refer to either a single business location or a chain of business locations of the same entity.

The terms “payment network” and “card network” are used interchangeably throughout the description and refer to a network or collection of systems used for the transfer of funds through the use of cash substitutes. Payment networks may use a variety of different protocols and procedures in order to process the transfer of money for various types of transactions. Payment networks are companies that connect an issuing bank with an acquiring bank to facilitate an online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit, checks, financial accounts, etc.

The term “payment card”, used throughout the description, refers to a physical or virtual card linked with a financial or payment account that may be presented to a merchant or any such facility to fund a financial transaction via the associated payment account. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the merchant for funding the payment. Alternatively, or additionally, the payment card may be embodied in the form of data stored in a user device, where the data is associated with a payment account such that the data can be used to process the financial transaction between the payment account and a merchant's financial account.

The term “payment account”, used throughout the description refers to a financial account that is used to fund a financial transaction. Examples of the financial account include, but are not limited to a savings account, a credit account, a checking account, and a virtual payment account. The financial account may be associated with an entity, such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction”, “financial transaction”, “event”, and “transaction” are used interchangeably throughout the description and refer to a transaction of payment of a certain amount being initiated by the cardholder. More specifically, refers to electronic financial transactions including, for example, online payment, payment at a terminal (e.g., Point of Sale (POS) terminal), and the like. Generally, a payment transaction is performed between two entities, such as a buyer and a seller. It is to be noted that a payment transaction is followed by a payment transfer of a transaction amount (i.e., monetary value) from one entity (e.g., issuing bank associated with the buyer) to another entity (e.g., acquiring bank associated with the seller), in exchange of any goods or services.

The term ‘set’ refers to a collection of well-defined, unordered objects called elements or members. For example, the phrases a ‘set of entities’, and a ‘set of nodes’ refer to collection of nodes and entities, respectively.

### OVERVIEW

Various embodiments of the present disclosure provide methods, systems, user devices, and computer program products for processing a temporal bipartite graph using an Artificial Intelligence (AI) or Machine Learning (ML) model to learn representations for nodes of the temporal bipartite graph.

As described earlier, there are multiple challenges in learning the temporal representation of dynamic bipartite graphs as each node-set of a bipartite graph could have a unique set of features. For example, in a financial transaction dataset, users (or cardholders) and merchants form the node-set of a bipartite graph. The purchase patterns of cardholders evolve indicating complex interactions with multiple merchants. Now, cardholder's attributes may include issuer bank, credit score, card product type, etc., among other suitable attributes. On the other hand, merchants will have attributes like category code, geolocation, type of service, etc., among other suitable attributes. Clearly, the raw attributes of the cardholder and merchant describe different things and should not be combined homogeneously. Their representations should be disentangled from each other to preserve their identity as cardholders or merchants. Another factor is the evolving nature of the bipartite graph. It demands modeling of time aspects to predict future behaviors like dynamic link prediction realistically. It plays a critical part in temporal recommendation tasks.

To address the shortcomings of the various conventional techniques, a novel method to model the temporal characteristic of a bipartite graph is proposed. To disentangle the representation of each node-set with unique features, a Graph Neural Network (GNN) model with an attention layer called a bipartite graph transformer (BGT) layer is introduced. The BGT layer is responsible for aggregating features of the same node types using two-hop neighborhood node aggregation where only structural information from the one-hop neighbors is used. For example, in the financial graph, to aggregate features of cardholders using two-hop neighbor nodes (i.e., other cardholders), the structure of merchants (i.e., one-hop neighbor nodes) is used to find two-hop neighbor nodes of the concerned cardholder. Further, to preserve the community structure of individual node-sets, a homogeneous node representation is introduced. To learn the representation of the temporal edge, a combination of the homogeneous representation of the source node and destination node, i.e., the distinct nodes connected by the respective edge is generated. Also, a local heterogeneous representation of the edge is learned to define a long-range temporal relationship between the source and destination node. Finally, using information maximization, a global homogeneous edge representation and a local heterogeneous edge representation of a node can be aligned. To perform this process, a server system configured to perform various operations is described.

In an embodiment, the server system includes a processor, a communication interface, and a memory. In an instance, the server system can be implemented within is a payment server associated with a payment network. In an embodiment, the server system is configured to access an entity dataset from the database associated with the server system. The entity dataset may include a plurality of first features related to each first entity of a plurality of first entities and a plurality of second features related to each second entity of a plurality of second entities. In a non-limiting implementation, the plurality of first entities is one of a plurality of cardholders or a plurality of merchants, and the plurality of second entities is one of the plurality of merchants or the plurality of cardholders, respectively. Then, the server system is configured to generate and store a temporal bipartite graph based, at least in part, on the plurality of first features and the plurality of second features. Herein, each first node of the set of first nodes represents an individual first entity from the plurality of first entities and is associated with the corresponding plurality of first features. Each second node of the set of second nodes represents an individual second entity from the plurality of second entities and is associated with the corresponding plurality of second features. Each edge of the plurality of edges indicates information related to a temporal relationship between two distinct nodes connected by each edge.

In a scenario, if the temporal bipartite graph is already generated, then the server system is configured to access a temporal bipartite graph from a database associated with the server system. Then, the server system is configured to generate, by a Graph Neural Network (GNN) model associated with the server system, a set of first interim representations for each first node based, at least in part, on the plurality of first features corresponding to each of a set of temporal two-hop neighbor nodes of each first node. Thereafter, the server system is configured to compute, by the GNN model, a first homogeneous representation for each first node based, at least in part, on the set of first interim representations for each first node and the plurality of first features corresponding to each first node. Further, the server system is configured to compute a first global homogeneous representation for each first node based, at least in part, on the first homogeneous representation for each first node.

Additionally, the server system is configured to generate, by the GNN model, a set of second interim representations for each second node based, at least in part, on the plurality of second features corresponding to each of a set of temporal two-hop neighbor nodes of each second node. Then, the server system is configured to compute, by the GNN model, the second homogeneous representation for each second node based, at least in part, on the set of second interim representations for each second node and the plurality of second features corresponding to each second node.

Thereafter, the server system is configured to determine or compute the first local heterogeneous representation for each first node based, at least in part, on the first homogeneous representation for each first node and a second homogeneous representation for each second node. Similarly, the server system is configured to compute a second local heterogeneous representation for each second node based, at least in part, on the first homogeneous representation for each first node and the second homogeneous representation for each second node. Then, the server system is configured to compute a second global homogeneous representation for each second node based, at least in part, on the second homogeneous representation for each second node.

In another embodiment, the server system is configured to compute an edge local heterogeneous representation for each edge connecting each first node and each second node based, at least in part, on concatenating the first local heterogeneous representation for each first node and the second local heterogeneous representation for each second node. Further, the server system is configured to compute an edge global homogeneous representation for each edge connecting each first node and each second node based, at least in part, on concatenating the first global homogeneous representation for each first node and the second global homogeneous representation for each second node.

In another embodiment, the server system is configured to perform a downstream task such as link prediction. In particular, the server system receives a task request for performing a downstream task for a particular first node in the temporal bipartite graph. In response, the server system generates, by a classifier model associated with the server system, a prediction for the downstream task based, at least in part, on the corresponding first local heterogeneous representation and the corresponding first global homogeneous representation of the particular first node. It is noted that the same process can be performed for the second node using corresponding values as well.

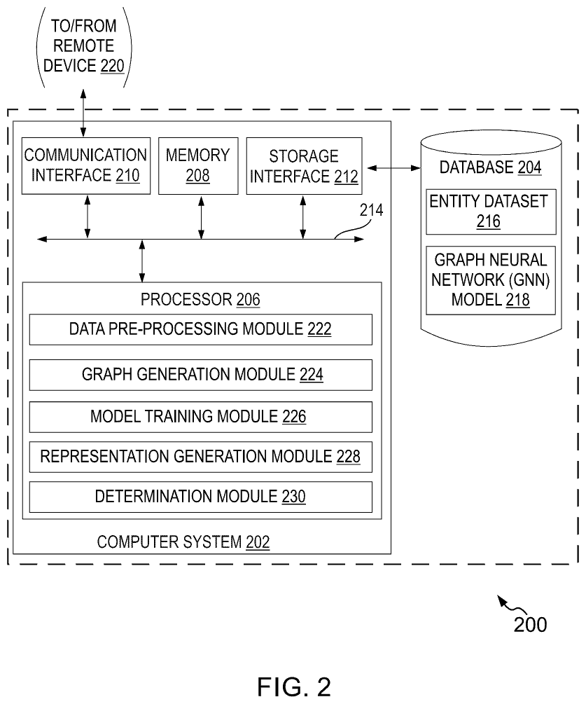

To that end, the various embodiments of the present disclosure provide multiple advantages and technical effects while addressing technical problems such as how to learn or generate representations (or embeddings) for each node of the temporal bipartite graph. To that end, the various embodiments of the present disclosure provide an approach for learning or generating representations (or embeddings) for each node of the temporal bipartite graph. As described herein, a server system is configured to operate a GNN model including the BGT layer that helps to disentangle the representations of each node-set from the bipartite graph. Further, on top of the bipartite graph transformer layer, information maximization is applied to align global homogeneous and local heterogeneous edge representation. This aspect helps to preserve the local community structure within each node-set and to learn long-range temporal dependencies from the temporal bipartite graphs. An example application of the proposed invention has been described with the help of a down-stream task known as link prediction later with reference to FIG. 2.

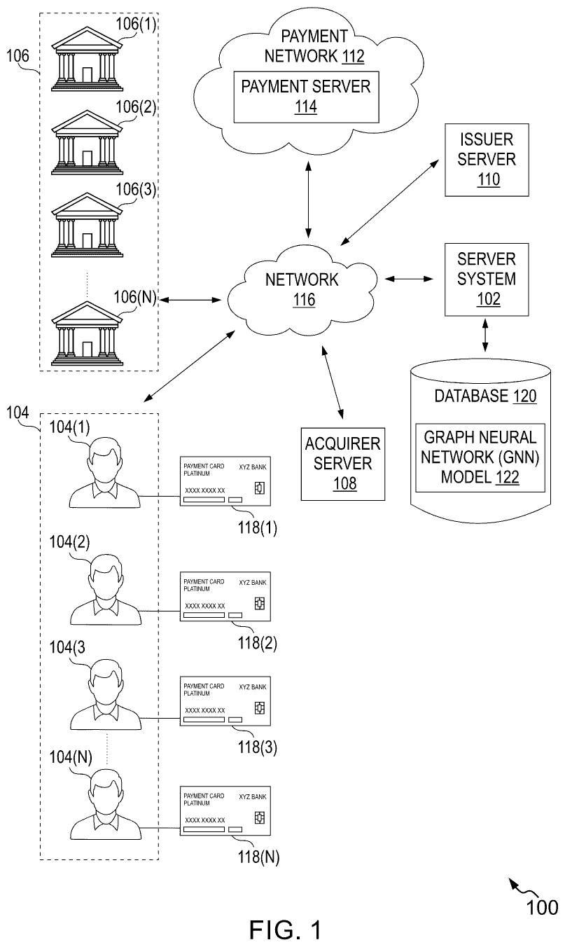

Various embodiments of the present disclosure are described hereinafter with reference to FIGS. 1 to 12.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, generating a temporal bipartite graph, processing a temporal bipartite graph using AI/ML models, computing representations for each node and edge of the temporal bipartite graph, performing downstream tasks using the computed representations, and the like.

The environment 100 generally includes a plurality of entities, such as a server system 102, a plurality of cardholders 104(1), 104(2), . . . 104(N) (collectively, referred to as ‘a plurality of cardholders 104’ and ‘N’ is a non-zero Natural number), a plurality of merchants 106(1), 106(2), . . . 106(N) (collectively, referred to as ‘a plurality of merchants 106’ and ‘N’ is a non-zero Natural number), an acquirer server 108, an issuer server 110, and a payment network 112 including a payment server 114, each coupled to, and in communication with (and/or with access to) a network 116. It is noted that the value of N may be different for cardholders and merchants. The network 116 may include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an Infrared (IR) network, a Radio Frequency (RF) network, a virtual network, and/or another suitable public and/or private network capable of supporting communication among two or more of the parts or users illustrated in FIG. 1, or any combination thereof.

Various entities in the environment 100 may connect to the network 116 in accordance with various wired and wireless communication protocols, such as Transmission Control Protocol/Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 116 may include multiple different networks, such as a private network made accessible by the server system 102 and a public network (e.g., the Internet, etc.) through which the server system 102, the acquirer server 108, the issuer server 110, and the payment server 114 may communicate.

In an embodiment, the plurality of cardholders 104 use one or more payment cards 118(1), 118(2), . . . 118(N) (collectively, referred to hereinafter as a plurality of payment cards 118 and ‘N’ is a non-zero Natural number) respectively to make payment transactions. The cardholder (e.g., the cardholder 104(1)) may be any individual, representative of a corporate entity, a non-profit organization, or any other person who is presenting payment account details during an electronic payment transaction. The cardholder (e.g., the cardholder 104(1)) may have a payment account issued by an issuing bank (not shown in figures) associated with the issuer server 110 (explained later) and may be provided a payment card (e.g., the payment card 118(1)) with financial or other account information encoded onto the payment card (e.g., the payment card 118(1)) such that the cardholder (i.e., the cardholder 104(1)) may use the payment card 118(1) to initiate and complete a payment transaction using a bank account at the issuing bank. Herein, the plurality of cardholders 104 may be an example of a plurality of first entities.

In an example, the plurality of cardholders 104 may use their corresponding electronic devices (not shown in figures) to access a mobile application or a website associated with the issuing bank, or any third-party payment application. In various non-limiting examples, the electronic devices may refer to any electronic devices, such as, but not limited to, Personal Computers (PCs), tablet devices, Personal Digital Assistants (PDAs), voice-activated assistants, Virtual Reality (VR) devices, smartphones, and laptops.

The plurality of merchants 106 may include retail shops, restaurants, supermarkets or establishments, government and/or private agencies, or any such places equipped with POS terminals, where customers visit to perform financial transactions in exchange for any goods and/or services or any financial transactions. Herein, the plurality of merchants 106 may be an example of a plurality of second entities.

In one scenario, the plurality of cardholders 104 may use their corresponding payment accounts to conduct payment transactions with the plurality of merchants 106. Moreover, it may be noted that each of the plurality of cardholders 104 may use their corresponding plurality of payment cards 118 differently or make the payment transaction using different means of payment. For instance, the cardholder 104(1) may enter payment account details on an electronic device (not shown) associated with the cardholder 104(1) to perform an online payment transaction. In another example, the cardholder 104(2) may utilize the payment card 118(2) to perform an offline payment transaction. It is understood that generally, the term “payment transaction” refers to an agreement that is carried out between a buyer and a seller to exchange goods or services in exchange for assets in the form of a payment (e.g., cash, fiat-currency, digital asset, cryptographic currency, coins, tokens, etc.). For example, the cardholder 104(3) may enter details of the payment card 118(3) to transfer funds in the form of fiat currency on an e-commerce platform to buy goods. In another instance, each cardholder of the plurality of cardholders 104 (e.g., the cardholder 104(1)) may transact at any merchant from the plurality of merchants 106 (e.g., the merchant 106(1)).

In one embodiment, the plurality of cardholders 104 is associated with the issuer server 110. In one embodiment, the issuer server 110 is associated with a financial institution normally called an “issuer bank”, “issuing bank” or simply “issuer”, in which a cardholder (e.g., the cardholder 104(1)) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an embodiment, the plurality of merchants 106 is associated with the acquirer server 108. In an embodiment, each merchant (e.g., the merchant 106(1)) is associated with an acquirer server (e.g., the acquirer server 108). In one embodiment, the acquirer server 108 is associated with a financial institution (e.g., a bank) that processes financial transactions. This can be an institution that facilitates the processing of payment transactions for physical stores, merchants (e.g., the merchants 106), or institutions that own platforms that make either online purchases or purchases made via software applications possible (e.g., shopping cart platform providers and in-app payment processing providers). The terms “acquirer”, “acquiring bank”, “acquiring bank” or “acquirer server” will be used interchangeably herein.

As explained earlier, there are multiple challenges in learning the temporal representation of dynamic bipartite graphs as each node-set of a bipartite graph could have a unique set of features. For example, in a financial transaction dataset, the plurality of users (or cardholders) and the plurality of merchants 106 forms the node-set of a temporal bipartite graph. The purchase patterns of plurality of cardholders 104 evolve indicating complex interactions with multiple merchants. Now, cardholder's attributes may include issuer bank, credit score, card product type, etc., among other suitable attributes. On the other hand, merchants 106 will have attributes like category code, geolocation, type of service, etc., among other suitable attributes. Clearly, the raw attributes of the plurality of cardholders 104 and merchants 106 describe different things and should not be combined homogeneously. Their representations should be disentangled from each other to preserve their identity as cardholders or merchants. Another factor is the evolving nature of the bipartite graph. It demands modeling of time aspects to predict future behaviors like dynamic link prediction realistically. It plays a critical part in temporal recommendation tasks.

The above-mentioned technical problem among other problems is addressed by one or more embodiments implemented by the server system 102 of the present disclosure. In one embodiment, the server system 102 is configured to perform one or more of the operations described herein.

In one embodiment, the environment 100 may further include a database 120 coupled with the server system 102. In an example, the server system 102 coupled with the database 120 is embodied within the payment server 114, however, in other examples, the server system 102 can be a standalone component (acting as a hub) connected to the acquirer server 108 and the issuer server 110. The database 120 may be incorporated in the server system 102 or maybe an individual entity connected to the server system 102 or maybe a database stored in cloud storage. In one embodiment, the database 120 may store a Graph Neural Network (GNN) model 122, and other necessary machine instructions required for implementing the various functionalities of the server system 102, such as firmware data, operating system, and the like.

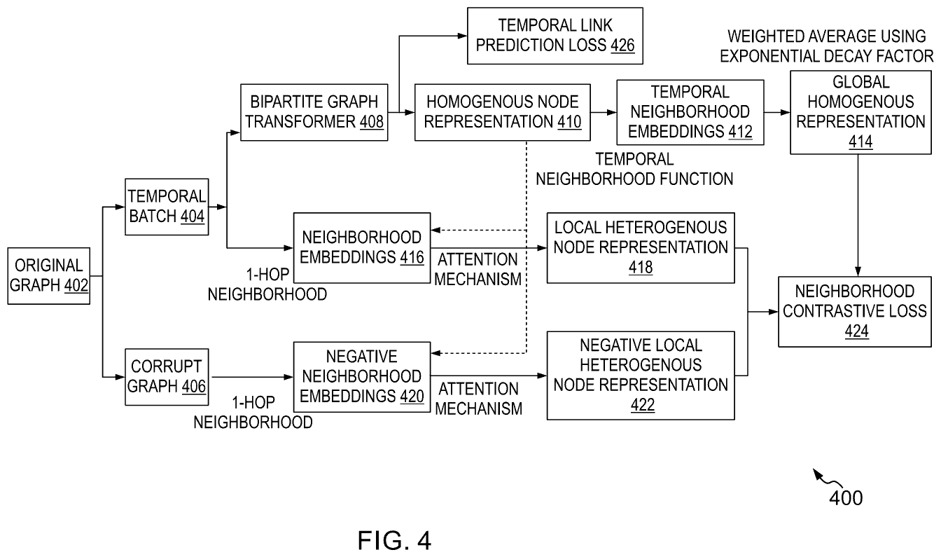

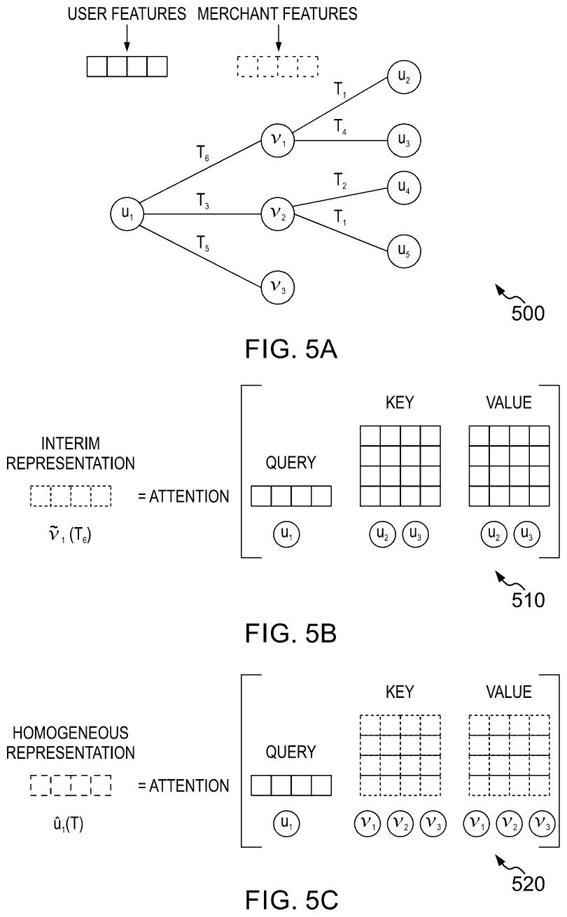

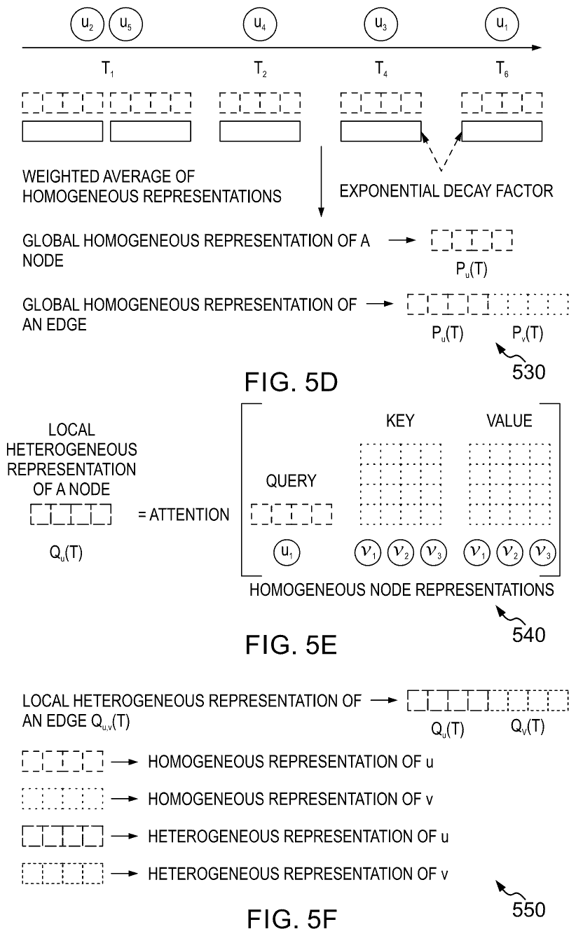

In an example, the GNN model 122 is an AI or ML based model that is configured or trained to perform a plurality of operations. In a non-limiting example, the GNN model 122 is a GNN-based model. The GNN model 122 further includes a bipartite graph transformer layer and a temporal bipartite graph encoder based on an attention mechanism. It is noted that the GNN model 122 has been explained in detail later in the present disclosure with reference to FIG. 4 and FIG. 5A to FIG. 5F. In addition, the database 120 provides a storage location for data and/or metadata obtained from various operations performed by the server system 102.

In an embodiment, the server system 102 is configured to access a temporal bipartite graph from the database 120. The temporal bipartite graph may include a set of first nodes, a set of second nodes, and a plurality of edges existing between the set of first nodes and the set of second nodes. The temporal graph may be generated using an entity dataset from a database. For instance, in the financial domain, the entity dataset may be a historical transaction dataset. In this scenario, the entity dataset includes real-time and historical transaction data of the plurality of cardholders 104 and the plurality of merchants 106. It is noted that the transaction data is associated with temporal information for the plurality of transactions performed between the plurality of cardholders 104 and the plurality of merchants 106 as well. In some instances, the transaction data may also be called merchant-cardholder interaction data as well.

The transaction data may include, but is not limited to, transaction attributes, such as transaction amount, source of funds, such as bank or credit cards, transaction timestamp, transaction channel used for loading funds such as POS terminal or ATM, transaction velocity features, such as count and transaction amount sent in the past ‘x’ number of days to a particular user, transaction location information, external data sources, merchant country, merchant Identifier (ID), cardholder ID, cardholder product, cardholder Permanent Account Number (PAN), Merchant Category Ccode (MCC), merchant location data or merchant co-ordinates, merchant industry, merchant super industry, ticket price, and other transaction-related data. The temporal bipartite graph may be generated such that each first node of the set of first nodes in the graph represents an individual first entity from the plurality of first entities and is associated with the corresponding plurality of first features for that first entity.

Further, the temporal bipartite graph may be generated such that each second node of the set of second nodes in the graph may represent an individual second entity from the plurality of second entities and be associated with a corresponding plurality of second features. Furthermore, each distinct type of node belonging to different node sets may be linked using an edge such that each edge of the plurality of edges indicates information related to a temporal relationship between two distinct nodes connected by that edge. For instance, in the financial domain, the set of first nodes (or the first node set) may represent the plurality of cardholders 104 and the set of second nodes (or the second node set) may represent the plurality of merchants 106. Further, the edge between a particular cardholder node and merchant node may indicate an interaction, such as a transaction along with its timestamp between the particular cardholder and the particular merchant. It is noted that although the various embodiments of the present disclosure have been explained with reference to the financial domain, the same should not be construed as a limitation of the scope of the same. As may be appreciated, the various embodiments of the present disclosure can be applied to various other domains, such as healthcare, hospitality, social media, and so on, without exceeding the scope of the present disclosure.

Then, the server system 102 is configured to generate a set of first interim representations for each first node. Herein, for a first node, the set of first interim representations is generated based, at least in part, on the plurality of first features corresponding to each of a set of temporal two-hop neighbor nodes of the first node. As may be understood, the set of temporal two-hop neighbor nodes is the one-hop neighbor node of each second node connected with each first node. For example, in the financial domain, for a temporal bipartite graph representing transactions between cardholders and merchants, a two-hop neighbor for one cardholder node would be other cardholder nodes while the merchant nodes would be a one-hop neighbor node of the cardholder nodes. It is noted that since, temporal bipartite graphs as dynamic in nature, the neighbors of any node are determined based on the timestamp associated with the edge connecting the nodes. This aspect has been described further with reference to FIG. 5A later in the present disclosure. Similarly, the server system 102 is configured to generate a set of second interim representations for each second node of the temporal bipartite graph. In a non-limiting example, a machine learning model such as the GNN model 122 may be used by the server system 102 to generate the set of first interim representations and the set of second interim representations. In particular, the bipartite graph transformer layer of the GNN model 122 uses two-hop features of the same node-set and structural information from one-hop neighbors of another node-set to learn the respective sets of interim representations which results in disentanglement of the representations of each node-set from the bipartite graph. More specifically, an attention mechanism is used to compute the interim representations for any node. This aspect has been described later in the present disclosure with reference to FIG. 5B.

Thereafter, the server system 102 is configured to compute using the GNN model 122 a first homogeneous representation for each first node based, at least in part, on the set of first interim representations for each first node and the plurality of first features corresponding to each first node. Similarly, a second homogeneous representation for each second node is computed. As may be appreciated, the homogeneous representation for each node set is learned entirely using features of the other nodes in the same set. More specifically, an attention mechanism is used to compute the homogeneous representation for any node. This aspect has been described later in the present disclosure with reference to FIG. 5C. Thereafter, the server system 102 may be configured to perform other operations as well, these operations along with the operations described earlier and explained further in detail with reference to FIG. 2.

In one embodiment, the payment network 112 may be used by the payment card issuing authorities as a payment interchange network. Examples of the plurality of payment cards 118 include debit cards, credit cards, etc.

It should be understood that the server system 102 is a separate part of the environment 100, and may operate apart from (but still in communication with, for example, via the network 116) any third-party external servers (to access data to perform the various operations described herein). However, in other embodiments, the server system 102 may be incorporated, in whole or in part, into one or more parts of the environment 100.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 116, which may be specifically configured, via executable instructions, to perform steps as described herein, and/or embodied in at least one non-transitory computer-readable media.

It is pertinent to note that the various embodiments of the present disclosure have been described herein with respect to examples from the financial domain, and it should be noted the various embodiments of the present disclosure can be applied to a wide variety of applications as well and the same will be covered within the scope of the present disclosure as well. To that end, the various embodiments of the present disclosure apply to various applications as long as a dataset pertaining to the desired application can be represented in the form of a temporal bipartite graph.

FIG. 2 illustrates a simplified block diagram of a server system 200, in accordance with an embodiment of the present disclosure. It is noted that the server system 200 is identical to the server system 102 of FIG. 1. In one embodiment, the server system 200 is a part of the payment network 112 or integrated within the payment server 114. In some embodiments, the server system 200 is embodied as a cloud-based and/or Software as a Service (SaaS) based architecture.

The server system 200 includes a computer system 202 and a database 204. It is noted that the database 204 is identical to the database 120 of FIG. 1. The computer system 202 includes at least one processor 206 for executing instructions, a memory 208, a communication interface 210, a user interface, and a storage interface 212 that communicate with each other via a bus 214.

In some embodiments, the database 204 is integrated into the computer system 202. For example, the computer system 202 may include one or more hard disk drives as the database 204. The user interface is any component capable of providing an administrator (not shown) of the server system 200, the ability to interact with the server system 200. This user interface may be a GUI or Human Machine Interface (HMI) that can be used by the administrator to configure the various operational parameters of the server system 200. The storage interface 212 is any component capable of providing the processor 206 with access to the database 204. The storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store an entity dataset 216, a GNN model 218, and the like. It is noted that the GNN model 218 is identical to the GNN model 122 of FIG. 1.

The processor 206 includes suitable logic, circuitry, and/or interfaces to execute operations for computing representations or embeddings for various nodes in a temporal bipartite graph and the like. In other words, the processor 206 includes suitable logic, circuitry, and/or interfaces to execute operations for the machine learning model such as the GNN model 218. Examples of the processor 206 include but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing various operations described herein. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device (i.e., to/from a remote device 220) such as the plurality of issuer servers 110, the plurality of acquirer servers 108, the payment server 114, or communicating with any entity connected to the network 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a data pre-processing module 222, a graph generation module 224, a model training module 226, a representation generation module 228, and a determination module 230. It should be noted that components, described herein, such as the data pre-processing module 222, the graph generation module 224, the model training module 226, the representation generation module 228, and the determination module 230 can be configured in a variety of ways, including electronic circuitries, digital arithmetic, and logic blocks, and memory systems in combination with software, firmware, and embedded technologies.

In an embodiment, the data pre-processing module 222 includes suitable logic and/or interfaces for accessing the entity dataset 216 from the database 204 associated with the server system 200. In particular, the entity dataset 216 may at least include information related to a plurality of entities. In one non-limiting example, the plurality of entities may include the plurality of cardholders 104, the plurality of merchants 106, a plurality of issuer servers (such as servers similar to the issuer server 110 depicted in FIG. 1), and a plurality of acquirer servers (such as servers similar to the acquirer server 108 depicted in FIG. 1). Further, the information related to these entities may include information related to a plurality of historical payment transactions performed by the plurality of cardholders 104 associated with the plurality of issuers with the plurality of merchants 106 associated with the plurality of acquirers. It is noted that this non-limiting example is specific to the financial industry or payment ecosystem. The entity dataset 216 can be configured to include different information specific to any field of operation as well. In other words, the various embodiments of the present disclosure apply to a variety of different fields of operation, and the same is covered within the scope of the present disclosure. Returning to the previous example, the plurality of historical payment transactions may be performed within a predetermined interval of time (e.g., 6 months, 12 months, 24 months, etc.) at different time stamps stored in the entity dataset 216.

In some other non-limiting examples, the entity dataset 216 includes information related to at least merchant name identifier, cardholder name, cardholder identifier, unique merchant identifier, timestamp information (i.e., transaction date/time), geo-location related data (i.e., latitude and longitude of the cardholder/merchant), Merchant Category Code (MCC), merchant industry, merchant super industry, information related to payment instruments involved in the set of historical payment transactions, cardholder identifier, Permanent Account Number (PAN), country code, transaction identifier, transaction amount, and the like.

In one example, entity dataset 216 may define a relationship between each of the plurality of entities. In a non-limiting example, a relationship between a cardholder account and a merchant account is established when a transaction takes place between them. For example, when a cardholder purchases an item from a merchant, a relationship is established.

In another embodiment, the entity dataset 216 may include information related to past payment transactions such as transaction markers (e.g., fraudulent or non-fraudulent, first-party fraud or third-party fraud, and so on), and the like. In yet another embodiment, the entity dataset 216 may include information related to the acquirer server 108 such as the date of merchant registration with the acquirer server 108, amount of payment transactions performed at the acquirer server 108 in a day, number of payment transactions performed at the acquirer server 108 in a day, maximum transaction amount, minimum transaction amount, number of fraudulent merchants or non-fraudulent merchants registered with the acquirer server 108, and the like.

In addition, the data pre-processing module 222 is configured to generate a plurality of first features related to each first entity of a plurality of first entities and a plurality of second features related to each second entity of a plurality of second entities based, at least in part, on the information stored in the entity dataset 216. In one instance, the first entity may be the cardholder and the second entity may be the merchant, or vice versa. In various non-limiting examples, the data pre-processing module 222 may utilize any feature generation approaches such as, but not limited to, one-hot encoding, binning, and the like to generate the first features and the second features, respectively. It is understood that such feature generation techniques are already known in the art, therefore the same are explained here for the sake of brevity. The data pre-processing module 222 may further store the generated features in the entity dataset 216 for further use by the various modules of the server system 200 as well. In other words, the entity dataset 216 may include a plurality of first features related to each first entity of a plurality of first entities and a plurality of second features related to each second entity of a plurality of second entities. In another embodiment, the data pre-processing module 222 is communicably coupled to the graph generation module 224 and is configured to transmit the plurality of first features and the plurality of second features to the graph generation module 224.

In an embodiment, the graph generation module 224 includes suitable logic and/or interfaces for generating a temporal bipartite graph based, at least in part, on the plurality of first features and the plurality of second features. In various non-limiting examples, the bipartite graph may include a set of first nodes, a set of second nodes, and a plurality of edges existing between the set of first nodes and the set of second nodes. In the temporal bipartite graph, each first node of the set of first nodes represents an individual first entity from the plurality of first entities and this node is associated with the corresponding plurality of first features of that node. Further, each second node of the set of second nodes represents an individual second entity from the plurality of second entities and this node is associated with the corresponding plurality of second features of that node. Furthermore, each edge of the plurality of edges indicates information related to a temporal relationship between two distinct nodes connected by that edge.

Herein, the distinct nodes refer to the set of first nodes (or ‘first node-set’) and the set of second nodes (or ‘second node-set’). For example, in the financial domain, the temporal bipartite graph may be generated for the plurality of cardholders 104 and the plurality of merchants 106 for dynamic or time-linked transactions. In this example, the temporal bipartite graph may be called a temporal cardholder-merchant bipartite graph or temporal merchant-cardholder bipartite graph. Further, the set of first nodes may correspond to the plurality of cardholders 104 and the set of second nodes may correspond to the plurality of merchants 106, or vice versa.

More specifically, at first, the set of first features for each first node, and the set of second features for each second node are fed to the graph generation module 224. Then, the graph generation module 224 determines one or more features required for the generation of the temporal bipartite graph by analyzing the information related to the plurality of first entities and the plurality of second entities included in the entity dataset 216. For instance, one or more features corresponding to a first entity may be included in a node of the set of first nodes, and features corresponding to a second entity may be included in a node of the set of second nodes.

Then, these two nodes (one node corresponding to the first entity and the other node corresponding to the second entity) may be connected with an edge between them. To that end, the nodes within the temporal bipartite graph may be connected with one or more edges between them. Herein, the edges may define the relationship between distinct nodes (i.e., nodes of different entity types). In a non-limiting example, the graph generation module 224 identifies the cardholders 104(1)-104(3) that have made payment transactions with the merchants 106(1)-106(3) based at least on the information related to historical payment transactions between the plurality of cardholders 104 and the plurality of merchants 106. More specifically, a temporal cardholder-merchant bipartite graph may be generated by representing the cardholders 104(1)-104(3) and the merchants 106(1)-106(3) as nodes of different types and connect these nodes with a set of edges that represent time-based transactions between the distinct nodes. An exemplary representation of a temporal bipartite graph has been explained further in detail later in the present disclosure with reference to FIG. 5A. Upon generation of the temporal bipartite graph, the temporal bipartite graph may be stored in the database 204 associated with the server system 200. It is noted that when the server system 200 has to determine representations for each node in the temporal bipartite graph, the server system 200 may access the temporal bipartite graph from the database 204. In a situation, where the temporal bipartite graph is not available, the server system 200 may generate the temporal bipartite graph based on the process described earlier.

In another embodiment, the graph generation module 224 is communicably coupled to the model training module 226 and the representation generation module 228 and is configured to transmit the temporal bipartite graph to the model training module 226 and the representation generation module 228.

In an embodiment, the model training module 226 includes suitable logic and/or interfaces for training, generating, or learning the GNN model 218 using various loss functions and the set of first features of each first node and the set of second features of each second node. It is noted that the process for training the GNN model 218 is described in detail later in the present disclosure.

In an embodiment, the representation generation module 228 includes suitable logic and/or interfaces for generating, by the GNN model 218, a set of first interim representations for each first node. The generation of the set of first interim representations for each node is based, at least in part, on the plurality of first features corresponding to each of a set of temporal two-hop neighbor nodes of the first node. As may be understood, the set of temporal two-hop neighbor nodes is a one-hop neighbor node of each second node connected with each first node. For example, for a cardholder node, the temporal two-hop neighbor node would be other cardholder nodes. Similarly, the representation generation module 228 is configured to generate, by the GNN model 218, a set of second interim representations for each second node. The generation of the set of second interim representations for each node is based, at least in part, on the plurality of second features corresponding to each of a set of temporal two-hop neighbor nodes of the second node. As may be understood, the set of temporal two-hop neighbor nodes is a one-hop neighbor node of each first node connected with each second node. For example, for a merchant node, the temporal two-hop neighbor node would be other merchant nodes.

In another embodiment, the representation generation module 228 is configured to compute, by the GNN model 218, a first homogeneous representation for each first node based, at least in part, on the set of first interim representations for each first node and the plurality of first features corresponding to each first node. Similarly, the representation generation module 228 is configured to compute, by the GNN model 218, a second homogeneous representation for each second node based, at least in part, on the set of second interim representations for each second node and the plurality of second features corresponding to each second node.

In another embodiment, the representation generation module 228 is configured to compute a first global homogeneous representation for each first node based, at least in part, on the first homogeneous representation for each first node and a decay function. Similarly, the representation generation module 228 is configured to compute a second global homogeneous representation for each second node based, at least in part, on the second homogeneous representation for each second node and a decay function.

In another embodiment, the representation generation module 228 is configured to compute an edge global homogeneous representation for each edge connecting each first node and each second node based, at least in part, on concatenating the first global homogeneous representation for each first node and the second global homogeneous representation for each second node.

In another embodiment, the representation generation module 228 is configured to compute a first local heterogeneous representation for each first node based, at least in part, on the first homogeneous representation for each first node and the second homogeneous representation for each second node. Similarly, the representation generation module 228 is configured to compute a second local heterogeneous representation for each second node based, at least in part, on the first homogeneous representation for each first node and the second homogeneous representation for each second node. Further, the representation generation module 228 is configured to compute an edge local heterogeneous representation for each edge connecting each first node and each second node based, at least in part, on concatenating the first local heterogeneous representation for each first node and the second local heterogeneous representation for each second node.

It is noted that the various embodiments associated with the representation generation module 228 are explained in detail later using FIG. 5B to FIG. 5F in the present disclosure.

In an embodiment, the determination module 230 includes suitable logic and/or interfaces for receiving a task request for performing a downstream task for a particular node in the temporal bipartite network. The task request may define a downstream task that has to be performed for the particular node. Upon determining the requested task, the determination module 230 is configured to process the temporal bipartite graph using the GNN model 218 to perform the requested task. For instance, if the requested task is a link prediction task for predicting a future second node connection for a particular first node. Then, the determination module 230 may process the temporal bipartite graph using the GNN model 218 along with a classifier model such as an additional classifier layer (such as a Multi-Layer Perceptron (MLP) layer) based, at least in part, on the corresponding first local heterogeneous representation and the corresponding first global homogeneous representation of the particular first node to predict the future second node with whom that particular node may perform a transaction in future. This aspect has been explained in detail later with reference to FIG. 5F in the present disclosure. It is understood that the alternative of this operation is also possible and prediction of a future first node for a particular second node may also be performed similarly.

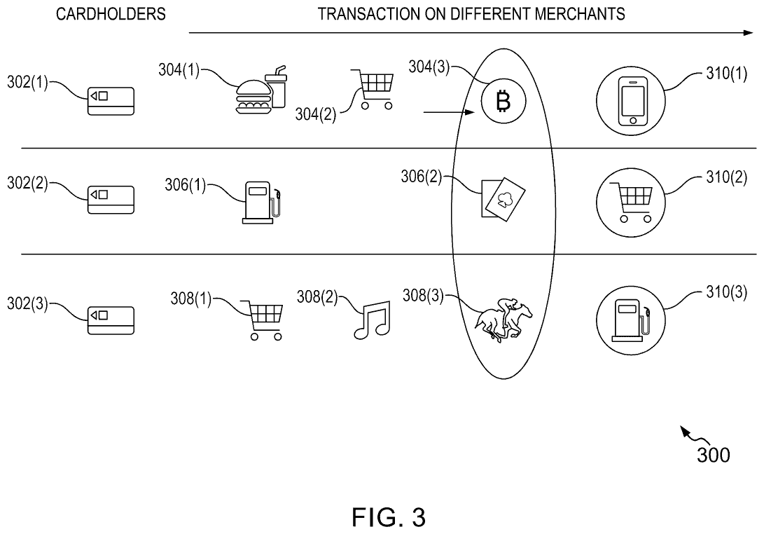

FIG. 3 illustrates an exemplary representation 300 of a financial transaction dataset (also, called historical transaction data), in accordance with an embodiment of the present disclosure. A financial transaction dataset may include information related to a plurality of first entities, a plurality of second entities, and a temporal relationship between the plurality of first entities and the plurality of second entities. In various non-limiting examples, the financial transaction dataset may include information related to a plurality of historical payment transactions performed within a predetermined interval of time (e.g., 6 months, 12 months, 24 months, etc.). In some other non-limiting examples, the financial transaction dataset includes information related to at least merchant name identifier, unique merchant identifier, timestamp information (i.e., transaction date/time), geo-location related data (i.e., latitude and longitude of the cardholder/merchant), Merchant Category Code (MCC), merchant industry, merchant super industry, information related to payment instruments involved in the set of historical payment transactions, cardholder identifier, Permanent Account Number (PAN), merchant name, country code, transaction identifier, transaction amount, and the like. As may be understood, high-risk merchants like crypto-trading, online betting, and gambling have very high fraud rates compared to others. These risky merchants form a cluster in the merchant node-set of the user-merchant temporal bipartite graph. When card details are compromised on one of the risky merchants, the proposed GNN model tries to predict the probability of the next transaction being fraudulent for other cardholders. This task is known as a link-prediction task.

As depicted, the financial transaction dataset may include information (i.e., data samples) regarding different cardholders such as 302(1), 302(2), and 302(3). Each of the data samples indicates a merchant and a time stamp at which an individual cardholder has performed a transaction. For instance, the cardholder 302(1) may have performed transactions at a fast-food merchant 304(1), a grocery merchant 304(2), and a crypto-currency trading merchant 304(3). Similarly, the cardholder 302(2) may have performed transactions at a fuel station merchant 306(1), and an online betting merchant 306(2). Further, the cardholder 302(3) may have performed transactions at a grocery merchant 308(1), a music merchant 308(2), and a gambling merchant 308(3). Now, if the crypto-currency trading merchant 304(3) commits fraud with the cardholder 302(1) and reports the same to the card provider, the concerned card can be labeled as compromised. After applying the proposed approach, the nodes representing these transactions with risky merchants may be clustered closer to each other within the representation space, this representation space may be analyzed by a classifier model to determine if the next transaction (see, 310(1), 310(2), and 310(3)) for a particular cardholder will be fraud or not.

FIG. 4 illustrates an architecture of a Graphical Neural Network (GNN) model 400, in accordance with an embodiment of the present disclosure.

At the onset, the temporal bipartite graph, i.e., the original graph 402 is given as input to the GNN model 400. The GNN model 400 is then configured to generate a temporal batch 404 of the original graph 402 based, at least in part, on the timestamps associated with the various edges of original graph 402. Further, the GNN model 400 is configured to generate a corrupt graph 406 by shuffling the edges of the original graph 402 between the same nodes. Then, the bipartite graph transformer layer 408 of the GNN model 400 is applied to each node in the temporal batch. The bipartite graph transformer layer 408 then, generates homogenous embeddings of the nodes or homogeneous node representation 410 from the temporal batch 404. This homogeneous node representation 410 is used to generate temporal neighborhood embeddings 412 by applying a temporal neighborhood function. Thereafter, a weighted average of the temporal neighborhood embeddings 412 is computed using an exponential decay factor to determine the global homogenous representation 414. Alternatively, the GNN model 400 generates a global homogenous representation 414 of nodes using a temporal neighborhood aggregation function.

In another embodiment, the GNN model 400 uses the homogeneous node representation 410 of each node to compute the neighborhood embeddings 416 for a one-hop neighborhood. Then, an attention mechanism is used to compute the local heterogeneous node representation 418 for each node in the neighborhood as well. In other words, the local heterogeneous node representation 418 of nodes is calculated by applying the attention mechanism on homogenous node representation 410. Further, the GNN model 400 uses the homogeneous node representation 410 of each node to compute the negative neighborhood embeddings 420 for the corrupt graph 406. Then, an attention mechanism is used to compute the negative local heterogeneous node representation 422 for each node in the one-hop neighborhood as well. In other words, the negative local heterogeneous node representation 422 of nodes is calculated by applying an attention mechanism on homogenous node representation 410 for the corrupt graph. Then, neighborhood contrastive loss 424 is computed using the global homogenous representation 414 of nodes, the local heterogeneous node representation 418 for each node, and the negative local heterogeneous node representation 422 of nodes.

Further, it is noted that the bipartite graph transformer is trained using two losses, namely, the link prediction loss 426 and the neighborhood contrastive loss 424. The operations of the various portions of the GNN model 400 have been explained later in the present disclosure.

FIG. 5A, FIG. 5B, FIG. 5C, FIG. 5D, FIG. 5E, and FIG. 5F, collectively, illustrate the various intermediate processes performed by a machine learning model such as the GNN model 218, in accordance with various embodiments of the present disclosure.

In particular, FIG. 5A illustrates a depiction of a simplified temporal bipartite graph 500 capturing interactions between users (i.e., cardholders) and merchants, in accordance with an embodiment of the present disclosure. Further, FIG. 5B illustrates the process 510 of generating an interim representation of the user u₁ with respect to merchant v₁, in accordance with an embodiment of the present disclosure. Further, FIG. 5C illustrates the process 520 of generating a homogeneous representation of u₁ using attention over multiple interim representations v₁, v₂ and v₃, in accordance with various embodiments of the present disclosure. Furthermore, FIG. 5D illustrates the process 530 of generating a global homogeneous representation of a node and a global homogeneous representation of an edge, in accordance with various embodiments of the present disclosure. Furthermore, FIG. 5E illustrates the process 540 of generating a local heterogeneous representation of a node, in accordance with various embodiments of the present disclosure. Furthermore, FIG. 5F illustrates the process 550 of generating a local heterogeneous representation of an edge, in accordance with various embodiments of the present disclosure.

As may be understood, a static graph can be defined as G=(V, ε). Here, the node set is V={1, . . . , n} and edges are ε∈V×V. The node features can be denoted by kₗ, whereas edge features are denoted by eₗⱼ, for all h, j=1, . . . , n, respectively. Generally, a typical graph neural network (GNN) model has two main components, message passing and neighborhood aggregation. In a non-limiting example, the message embedding mᵢⱼ and node embeddings zₗ may be computed using the following exemplary equation:

$${m}_{ij} = msg ( {k}_{l} , {k}_{j} , {e}_{ij} ) ; {z}_{l} = {\sum }_{j ∈ {ℕ}_{l}} h ( {m}_{lj} , {k}_{l} ) \qquad Eqn . ( 1 )$$

Here, Nₗ={j:(i, j)∈ε} is the neighborhood of node i. Also, msg and h are learnable functions.

Further, a bipartite graph can be represented as G=( [symbol] , V, ε), where [symbol] and V are two disjoint node sets, and ε∈ [symbol] ×V. In homogeneous networks, any node can have an edge over any other node. On the other hand, in bipartite graphs, nodes of the same set do not have any edge between them. If the representation algorithm does not account for this unique structural property of bipartite graphs, the learned representation might not be the optimal one. There exist two main categories in dynamic graphs as defined: (1) Discrete-time dynamic graphs (DTDG) are sequences of static graph snapshots in time. (2) Continuous-time dynamic graphs (CTDG) are series of ongoing events, such as (e, t). These events could be an edge between two nodes capturing an interaction or it could be node addition or deletion.

Dynamic bipartite graphs, denoted as G=( [symbol] , V, ε), consist of two distinct node types: [symbol] and V. Herein, these sets of nodes or node sets, namely the set of first nodes and the set of second nodes, satisfy the condition [symbol] ∩V=Ø, ensuring that there are no shared nodes between the two types of nodes. The graph further includes a set of edges e∈ε that connect the nodes in [symbol] to nodes in V characterized by timestamps (u∈ [symbol] , v∈V, t∈R⁺). To account for the possibility of multiple interactions between the same user (u∈ [symbol] ) and merchant (v∈V), the set ε can be treated as a multiset. In other words, each edge of the set of edges indicates information related to a temporal relationship between two distinct nodes in the temporal or dynamic bipartite graph.

For simplicity, it is assumed that all timestamps fall within the time interval [0, Tₘₐₓ]. Node feature representation functions for each node set may be defined as uₗ=fu(uₗ)∈R^{d}^{ᵤ} and vₗ=fV(vₗ)∈ [symbol] ^{d}^{ₛ}. As may be understood, the objective of dynamic bipartite graph representation learning is to learn meaningful and informative representations that capture the dynamic nature of the bipartite graph. These representations learned from the GNN model will facilitate performing of downstream tasks, such as link prediction, node classification, recommendation, and the like. A well-known example of a dynamic bipartite graph in the financial domain is the interaction between a user and a merchant, i.e., a transaction by the user on the merchant defines the temporal event (edge).

In an embodiment, a temporal bipartite graph is realized as a sequence of interactions where each interaction has a timestamp associated with it. The two sets of nodes or node sets represent real-world entities like user U and merchant V. Herein, the nodes belonging to the two entities may have different attributes representing their behavior. For example, in the financial graph, the user may have features like issuer bank details, card type (debit or credit), card product type, and the like. For merchants, these attributes may include the region of geolocation, product description, MCC, etc., among other suitable features. Clearly, these two node sets (i.e., the set of user nodes and the set of merchant nodes) have different behavior.

As depicted in FIG. 5A, there is no edge between the same entity type or node type in the bipartite graph, message passing in GNNs occurs only from the nodes of the other type (users interact with only merchants instead of other users). This aspect of dynamic bipartite graphs highlights the need for disentangled learning of these bipartite set features to preserve the distinctive properties of each node set. For instance, if a GNN algorithm considers both the node set features from the bipartite graph as similar, which is the case in homogeneous graph GNNs, it will lead to the intermixing of signals or node set specific distinctive properties. Such inefficient representations might provide sub-optimal performance in the downstream tasks.

To that end, the proposed GNN model is adapted to learn the distinctive representation of each node set in a bipartite graph. For explanation purposes, it is assumed that the GNN model has to calculate the representation of the user node u₁ at time t₆. To that end, it is considered that only those interactions of u₁, which have occurred before t₆. This is done to ensure that only past interactions can influence the current interaction. This causality on interaction time ensures that data is not leaked by looking ahead in time.

At the onset, the server system 200 is configured to generate a Temporal neighborhood function that is able to determine neighbors for a particular node, such as the user node u₁. To that end, for a given node u at time t, the temporal neighborhood function needs to find the neighbors interacting with it till time t. As would be apparent, for a bipartite graph, the neighbors are from the opposite node-set. In a non-limiting example, the temporal neighbor function can return neighboring nodes based on the exemplary Eqn. given below:

$${𝒩}_{u} ( t ) = v : ( u , 0 ) ∈ ε ( t ) \qquad Eqn . ( 2 )$$

where ε(t) contains edges that occurred prior to time t.

There are various temporal attention-based aggregation methods used widely due to their superior modeling ability. In the case of temporal bipartite graphs, the use of such well-known methods to aggregate node features from immediate neighbors will lead to intermixing of distinctive signals. To alleviate this issue, the two-hop attention-based aggregation technique of the present disclosure can be used. In the proposed approach, the homogeneous representation for each node set is learned entirely using features of the other nodes in the same set. For example, in the financial graph shown in graph 500, the representation of the user node is learned based on the features of other users instead of the merchant. Here, only the structural information from the opposite node set or the set of second nodes (i.e., merchant) is used to find the neighbors (i.e., other users). This procedure ensures a homogeneous representation for each node set.

As per the proposed approach, a two-step attention mechanism is designed. This procedure is explained in detail as follows: As depicted in FIG. 5A, the user u₁ interacts with merchant v₁ at time t₆. Also, it can be seen that there are other users like u₂ and u₃ interacting with the same merchant at times t₁ and t₄. As these interactions occurred in the past compared to u₁(t₆>t₄>t₁), users u₂ and u₃ are temporal two-hop neighbors of the user u₁. The next step is to calculate attention over two-hop neighbors (u₂ and u₃) of u₁ with respect to each one-hop neighbor (merchants v₁, v₂ and v₃ in FIG. 5A). An attention-based mechanism with functional time encoding is used to calculate the desired attention.

Consider the case of the merchant v₁, As depicted in FIG. 5B, attention is calculated with features of u₁ as query, features of all two-hop neighbors (u₂ and u₃) of u₁ as key and value. Herein, it is noted that the merchant node v₁ is only used to determine two-hop neighbors of the user node u₁. In other words, the features of the merchant v₁ are not used in calculating attention. This interim representation of two-hop neighbors (i.e., user nodes) at a one-hop merchant can be denoted by v̅₁. This procedure is repeated to calculate the interim representation of each merchant vᵢ where user u₁ has interacted. These representations are denoted as v̅₁(t₆), v̅₂(t₃) and v̅₃(t₅)) for merchants v₁, v₂ and v₃, respectively. In general, using Q K, and V as shorthand for query, key, and value, respectively, the attention function to calculate the interim representation of merchants (node-set V) may be defined using the non-limiting Eqn. given below:

$${\tilde{v}}_{j} ( t ) = Attention ( Q = {u}_{l} , K = V = {[ {u}_{k} ]}_{k = 1}^{n} ) \qquad Eqn . ( 3 )$$

where, uₖ∈ [symbol] (vⱼ(t)) and vⱼ∈ [symbol] (uₗ(t)).

The next attention step is applied over all interim representations as shown in FIG. 5C. Here, the homogeneous representation of the user node u₁ is realized through attention to each merchant's interim representations. Specifically, features of the user node u₁ form a query, all interim representations of the merchant (\tilde{v}₁(t₆), \hat{v}₂(t₃) and v̅₃(t₅)) form key and value. This homogeneous representation is denoted as û₁(t). In general, the homogeneous representation for users (node-set U) may be defined using the non-limiting Eqn. given below:

$${\hat{u}}_{i} ( t ) = Attention ( Q = {u}_{i} , K = V = {[ {\tilde{v}}_{J} ( t ) ]}_{j = 1}^{n} ) \qquad Eqn . ( 4 )$$

where, vⱼ∈ [symbol] (uₗ(t)).

Similarly, interim representation for user nodes (node-set U) may be defined using the non-limiting Eqn. given below:

$${\overline{u}}_{j} ( t ) = Attention ( Q = {v}_{i} , K = V = {[ {v}_{k} ]}_{k = 1}^{n} ) \qquad Eqn . ( 5 )$$

where, vₖ∈ [symbol] (uⱼ(t) and uⱼ∈ [symbol] (vᵢ(t).

Further, the homogeneous representation for merchant nodes (node-set V) may be defined using the non-limiting Eqn. given below:

$${\hat{θ}}_{i} ( t ) = Attention ( Q = {v}_{i} , K = V = {[ {\overline{u}}_{j} ( t ) ]}_{j = 1}^{n} ) \qquad Eqn . ( 6 )$$

where, uⱼ∈ [symbol] (vₗ(t)).

This homogeneous representation of users ûₗ(t) and merchants \hat{θ}ᵢ(t) are realized through the layer of the GNN model called as bipartite graph transformer layer. Note that multiple such layers can be used depending on the downstream task.

Once the homogeneous representations for each node in a bipartite graph are generated, different downstream tasks, such as the downstream task of dynamic link prediction may be performed. As the dynamic link is nothing but the interaction between two nodes (temporal edge), it is proposed to formulate two edge-specific representations as a global homogeneous representation and a local heterogeneous representation. The global homogeneous representation tries to model the homogeneous dynamics of each node in the edge. For example, the user and merchant interaction, models how each user (or merchant) is related to another user (or another merchant) in the same node-set. As edge connects two different node sets (i.e., user and merchant), there exists the need to model this heterogeneous relationship, as well. These two edge representations, i.e., global homogeneous and local heterogeneous representations are derived.

Global homogeneous representation of the edge: The bipartite GNN provides a homogeneous representation for every node in each node-set. For users, it is ûᵢ(t) and for merchants, it is \dot{î}ᵢ(t). To calculate the global homogeneous representation for each node-set, each node's homogeneous representation can be multiplied with exponential decay and a weighted average can be computed. In a non-liming implementation, the the global homogeneous representation for each node-set may be computed using the non-limiting Eqns. given below:

$${p}_{u} ( t ) = {\sum }_{i = 1}^{w} \frac{1}{{( 1 + η )}^{i}} {\hat{u}}_{i} ( t ) \qquad Eqn . ( 7 )$$

$${p}_{v} ( t ) = {\sum }_{i = 1}^{w} \frac{1}{{( 1 + η )}^{i}} {\hat{ν}}_{i} ( t ) \qquad Eqn . ( 8 )$$

where η is a hyperparameter and w is the size of the window. In a non-limiting implementation, these values can be set as follows: η=0.01 and w=100. It is noted that each node is considered in the order it is observed in the network.

Further, the global homogeneous representation of the edge may be computed by concatenating the representations of the two associated nodes as p_{u,v}(t)=pᵤ(t)∥pᵥ(t). The various steps involved in computing ρ_{u,v}(t) are shown in FIG. 5D.

As described earlier, an edge defines an interaction between user and merchant, i.e., the two opposite node set entities, this behavior can be modeled as a local heterogeneous representation. In a non-limiting implementation, the attention function uses homogeneous representations of the one-hop neighbors as follows (as depicted in FIG. 5D):

$${q}_{u} ( t ) = Attention ( Q = \tilde{u} , K = V = {[ {\hat{ν}}_{j} ( t ) ]}_{j = 1}^{n} \qquad Eqn . ( 9 )$$

where, vⱼ∈ [symbol] (uₗ(t)). Similarly, for the other node-set, the local heterogeneous representation may be computed using the following exemplary Eqn.:

$${q}_{u} ( t ) = Attention ( Q = \hat{t} , K = V = {[ {\hat{u}}_{j} ( t ) ]}_{j = 1}^{n} \qquad Eqn . ( 10 )$$

where, uⱼ∈ [symbol] (vᵢ(t)).

Then, the local heterogeneous representation of the edge can be obtained by simply concatenating node representations from previous steps as q_{u,0}(t)=qᵤ(t)∥qᵥ(t) in a non-limiting implementation.

As may be understood, the global homogeneous representation and local heterogeneous representation of the edge capture the edge dynamics under different contexts. As both these representations indicate the same event, the information content of them also should be the same. This can be realized by the information maximization objective where global and local representations of the edge are aligned with respect to each other. This objective is reformulated as noise contrastive loss, where, positive edges are from the training dataset and negative edges are sampled from the corrupt version \tilde{G} of the input graph G. The following procedure is followed to generate a temporal corrupt graph \tilde{G}. In a non-limiting example, the noise contrastive loss may be defined using the following exemplary Eqn:

$$Eqn . ( 11 )$$

$${ℒ}_{NC} = - \frac{1}{\vert ε \vert + \vert \tilde{ε} \vert} \text{} ( {\sum }_{i = 1}^{\vert ε \vert} {𝔼}_{G} [ log 𝒟 ( {p}_{u , v} ( t ) , {q}_{u , v} ( t ) ) ] + {\sum }_{i = 1}^{\vert \tilde{E} \vert} {𝔼}_{\tilde{G}} [ log ( 1 - 𝒟 ( {p}_{u , v} ( t ) , {\tilde{q}}_{u , v} ( t ) ) ) ] )$$

Here, \tilde{q}_{u,v}(t) is the local heterogeneous edge representation of the edge sample from edge set ε of a corrupt graph G. Also, [symbol] is a discriminator used to classify positive and negative representations.

Along with noise contrastive loss [symbol] _{NC}, the GNN model such as GNN model 218 is also trained using the time-sensitive link prediction loss function for training the attention layers of the bipartite graph. In a non-limiting example, the time-sensitive link prediction loss may be defined by the following exemplary Eqn.:

$$Eqn . ( 12 )$$

$${ℒ}_{LP} = {\sum }_{( {u}_{i} , {v}_{j} , {t}_{ij} ) ∈ ε} - log ( σ ( - {{\hat{u}}_{i} ( {t}_{ij} )}^{T} {\hat{v}}_{j} ( {t}_{ij} ) ) ) - Q \cdot {𝔼}_{( {u}_{i} , {v}_{q} , {t}_{ij} ) ∈ \tilde{ε}} log ( σ ( {{\hat{u}}_{i} ( {t}_{ij} )}^{T} {\hat{v}}_{q} ( {t}_{ij} ) ) )$$

where the summation is over the observed edges on the nodes uᵢ and vⱼ with interaction time tᵢⱼ. The σ is the sigmoid function and Q is the number of negative edges sampled from the edge set E of the corrupt graph \tilde{G}.

To train the GNN model 218 in an end-to-end manner, an affine combination of the two loss functions is utilized, which allows us to learn the discrimination between the observed graph and the corrupt graph at both the global homogeneous and local heterogeneous. The overall loss function may be defined by the following exemplary Eqn.:

$$ℒ = α {L}_{NC} + ( 1 - α ) {ℒ}_{LP} \qquad Eqn . ( 13 )$$

where α is a hyperparameter that determines the weight assigned to each loss term. By combining the noise contrastive loss [symbol] _{NC} and the temporal link prediction loss [symbol] _{LP}, the GNN model benefits from both local graph topology information and the temporal dynamics captured in the subgraph representations. This joint optimization enables effective disentanglement of node-sets and representation learning in temporal bipartite graphs.

It is noted that various experiments have been conducted on publicly available datasets to train and test the GNN model 218. In particular, extensive experimentation has been performed with different tasks using four open (i.e., publicly available) benchmark datasets including two digital payment datasets and two social media datasets. These datasets include the Elo Merchant dataset, the International Business Machines (IBM) Transaction dataset, the Wikipedia dataset, and the Reddit dataset. It is noted that Table 1 lists the statistics for different datasets including the number of nodes of each type, types of nodes, and number of edges in the graph.

TABLE 1
Statistics of datasets

| Dataset | \|U\| | \|V\| | \|E\| | Avg. Degree |
|---|---|---|---|---|
| Wikipedia Dataset | 8,227 | 1,000 | 57,474 | 12.46 |
| Elo-Merchant Dataset | 1,466 | 32,687 | 150,606 | 8.82 |
| IBM Transaction dataset | 162 | 416 | 222,617 | 385.15 |
| Reddit dataset | 10,000 | 984 | 672,447 | 61.22 |

Herein, the Elo Merchant dataset is a transaction dataset of Elo, i.e., one of the largest payment brands in Brazil that has built partnerships with merchants to offer cardholders promotions or discounts. Elo merchant dataset is a transactional dataset used for merchant category prediction. The dataset contains a user-merchant graph including about 1,466 users, about 32,687 merchants, and around 150,606 transactions.

The IBM Transaction dataset is a transaction dataset that contains data related to transactions generated from a multi-agent virtual world simulation performed by IBM. The data covers about 162 (synthetic) consumers in the United States who travel worldwide. It includes decades of purchase related information.

The Wikipedia Dataset contains data from top edited pages and active users. This dataset is used to generate or yield a temporal bipartite graph with around 9,300 nodes and 160,000 temporal edges. In this temporal bipartite graph, dynamic labels indicate if users are temporarily banned from editing and the user edits are treated as an edge feature.

The Reddit dataset contains data from active users and their posts under subreddits. This dataset is used to generate or yield a temporal bipartite graph with around 11,000 nodes, nearly 700,000 temporal edges, dynamic labels indicating whether a user is banned from posting, and user posts are transformed into edge feature vectors.

At the onset, the proposed approach is assessed using temporal link prediction as a downstream task. For experimental purposes, the temporal link prediction for a bipartite graph G is defined as the task of predicting whether there should be an interaction between node u∈ [symbol] and v∈V at time t.

The data for the bipartite graph is divided into a train, a validation, and test splits of 70%, 15%, and 15%, respectively. The experiments are performed in two settings: Transductive setting, i.e., if for every edge both the associated nodes appear in the training set, and Inductive setting, i.e., if at least one of the nodes is not there in the training set. For the Inductive setting, 10% of nodes are sampled from the test set. Then, they are removed from the training set to ensure a sufficient number of new nodes while testing. The proposed GNN model 218 is combined with a classifier model such as a simple MLP classifier which uses the concatenation of two node embeddings to predict a link. At first, an equal amount of negative node pairs to the positive links are sampled to evaluate the link prediction task. Then, the average precision (AP) and area under the receiver operating characteristic (ROC) curve (AUC) are computed. In an instance, an adaptive movement estimation (ADAM) optimizer is used to train the GNN model in an end-to-end fashion. Further, PyTorch frame has been used for the implementation of the GNN model 218. A learning rate of 1e−3 is used for all datasets, the batch size is set to 100, and the number of samples in the neighborhood is set to 10. The attention is realized using two Temporal Graph Attention (TGAT) layers and two attention heads with a 0.1 dropout rate. For the Reddit dataset and Wikipedia dataset, different settings are used to get the best performance.

The conventional homogeneous graph models such as the Graph Attention network (GAT) and GraphSAGE model are extended to use edge features in line with inductive representation learning. It is noted that GAT and GraphSAGE are not temporal models, thus, only the latest temporal edges are used in training and all edges are used in validation and testing. Therefore, static methods like BINE and BIGI are also extended to the temporal setting for a fair comparison. As BIGI does not have inductive capabilities, experiments follow transductive settings. The dynamic baselines include Dyrep and BiDyn. The experiments on BiDyn follow a transductive setting. Other baselines include the homogeneous temporal graph algorithm TGAT and recurrent neural network-based JODIE. It is noted that Table 2 shows the model performance of the proposed approach on the transductive link prediction.

As can be seen from Table 2, the proposed approach outperforms most models in all the datasets. From Table 1, the IBM Transaction dataset and Reddit dataset have high connectivity compared to the Wikipedia dataset and the Elo Merchant dataset. As more connectivity reveals the properties of the community in the node set of the bipartite graph, the performance of the proposed approach is measurably better on these datasets. It is noted that various results shown in Table 2 are experimental in nature and may be associated with an error of ±5-10%. In other words, if the experiments described herein are repeated in a different setting, these results are subject to vary due to a change in the experimental conditions.

TABLE 2
Results for Transductive link prediction.

| | Wikipedia | | Elo-Merchant | | IBM | | Reddit | |
|---|---|---|---|---|---|---|---|---|
| | dataset | | dataset | | dataset | | dataset | |
| Models | AP | AUC | AP | AUC | AP | AUC | AP | AUC |
| GraphSage | 87.11 | 86.93 | 73.7 | 69.42 | 87.05 | 90.54 | 92.88 | 95.93 |
| GAT | 86.01 | 84.17 | 87.38 | 87.84 | 82.01 | 82.96 | 95.66 | 96.34 |
| BINE | 43.4 | 38.64 | 46.10 | 43.32 | 44.74 | 44.90 | 47.91 | 47.93 |
| BIGI | 58.37 | 64.42 | 70.96 | 66.74 | 74.78 | 77.81 | 82.44 | 83.91 |
| BDDyn | 91.91 | 92.88 | 87.16 | 90.85 | 90.35 | 90.05 | 96.25 | 95.93 |
| TGAT | 94.63 | 94.90 | 85.10 | 81.70 | 89.90 | 88.70 | 98.12 | 96.65 |
| Dynrep | 94.64 | 93.62 | 89.52 | 90.00 | 89.36 | 90.00 | 96.90 | 97.10 |
| JODIE | 95.08 | 95.26 | 91.64 | 89.89 | 82.93 | 85.642 | 97.80 | 96.99 |
| Proposed | 97.36 | 97.15 | 88.89 | 88.84 | 93.40 | 93.00 | 98.30 | 98.10 |
| model | | | | | | | | |

Further, Table 3 shows results on inductive link prediction. As may be understood, inductivity is an essential property for most domains, e.g., in digital payments, new merchants and users are regularly introduced into the system. Therefore, it becomes essential for the model to infer new entities with reasonable accuracy. As described in the transductive results, graph connectivity plays an important role in results in this task as well. The proposed approach performs well in most of the cases compared to baselines. It is noted that various results shown in Table 3 are experimental in nature and may be associated with an error of ±5-10%. In other words, if the experiments described herein are repeated in a different setting, these results are subject to vary due to a change in the experimental conditions.

TABLE 3
Results for Inductive link prediction.

| | Wikipedia | | Elo-Merchant | | IBM | | Reddit | |
|---|---|---|---|---|---|---|---|---|
| | dataset | | dataset | | dataset | | dataset | |
| Models | AP | AUC | AP | AUC | AP | AUC | AP | AUC |
| GraphSage | 86.44 | 84.42 | 68.46 | 63.19 | 82.01 | 82.96 | 88.57 | 89.30 |
| GAT | 82.63 | 77.77 | 86.67 | 87.09 | 82.05 | 81.99 | 91.48 | 87.82 |
| BINE | 42.60 | 40.35 | 44.90 | 41.00 | 43.65 | 42.69 | 46.67 | 45.98 |
| BIGI | — | — | — | — | — | — | — | — |
| BiDyn | — | — | — | — | — | — | — | — |
| TGAT | 92.99 | 93.30 | 74.40 | 78.30 | 89.34 | 88.13 | 96.62 | 97.25 |
| Dyrep | 94.69 | 93.83 | 77.77 | 78.27 | 77.77 | 78.20 | 95.68 | 95.49 |
| JODIE | 93.00 | 92.70 | 77.30 | 77.83 | 82.93 | 85.64 | 94.36 | 93.94 |
| Proposed | 96.54 | 96.31 | 81.8 | 79.59 | 88.7 | 90.4 | 96.86 | 96.35 |
| model | | | | | | | | |

Further, the simple classification between positive and negative links can be extended to link prediction at specific timestamps to make the models relevant in real-world settings for experimental purposes. As may be understood, it would be beneficial if the model could rank all the possible entities that a node will interact with at a specific timestamp. To achieve this, the node representations are evaluated by different models on the temporal recommendation task. Here, 1000 negative links are sampled for every positive link. It is challenging as the negative links are being introduced at continuous time occurrences. Even if the user interacted with the merchant earlier, it is a negative link for the latter time instance. The models are configured to rank the likelihood of the links. Evaluation metrics, such as Hit@k and Mean Reciprocal Rank (MRR) have been used to determine the performance of these models. The results are shown in Table 4. As can be seen from Table 4, the proposed approach gives better results compared to baselines as it can capture both the aggregate-level temporal dynamics and the node-level local temporal dynamics. It is noted that various results shown in Table 4 are experimental in nature and may be associated with an error of ±5-10%. In other words, if the experiments described herein are repeated in a different setting, these results are subject to vary due to a change in the experimental conditions.

For a bipartite graph, the proposed model (i.e., the GNN model) is expected to capture the community structures of the homogeneous node sets. In a user-merchant bipartite graph, such clusters in the user node-set may represent the user spending habits or the fraud propensity. Similarly, clusters can be formed for merchants based on their industry. As shown in FIG. 3, merchants with high risk like gambling, online betting, and gambling should be a part of the same cluster. For visualizing the embeddings of the proposed model for a digital payments dataset in these clusters, PCA and t-SNE may be used. Once visualized, these clusters may indicate the community structure within each node-set.

TABLE 4
Results for temporal recommendation task.

| | Wikipedia | | | | Reddit | | | |
|---|---|---|---|---|---|---|---|---|
| | | Hit | Hit | Hit | | Hit | Hit | Hit |
| Models | MRR | @5 | @10 | @100 | MRR | @5 | @10 | @100 |
| Graph | 0.0038 | 0.0002 | 0.0004 | 0.0870 | 0.0050 | 0.0026 | 0.0052 | 0.0652 |
| Sage | | | | | | | | |
| GAT | 0.0040 | 0.0006 | 0.0008 | 0.0812 | 0.0054 | 0.0023 | 0.0053 | 0.0965 |
| BIGI | 0.0160 | 0.0170 | 0.0190 | 0.0380 | 0.0176 | 0.0260 | 0.0336 | 0.0940 |
| BiDyn | 0.0870 | 0.1420 | 0.1720 | 0.2610 | 0.0210 | 0.0300 | 0.0391 | 0.1090 |
| TGAT | 0.0900 | 0.1460 | 0.1780 | 0.2690 | 0.0570 | 0.0240 | 0.0570 | 0.0970 |
| Dyrep | 0.0270 | 0.0280 | 0.0400 | 0.0860 | 0.0210 | 0.0290 | 0.0400 | 0.1140 |
| JODIE | 0.0260 | 0.0270 | 0.0310 | 0.0620 | 0.0210 | 0.0310 | 0.0400 | 0.1120 |
| Proposed | 0.1400 | 0.1900 | 0.2600 | 0.6200 | 0.0580 | 0.0910 | 0.1390 | 0.4060 |
| model | | | | | | | | |

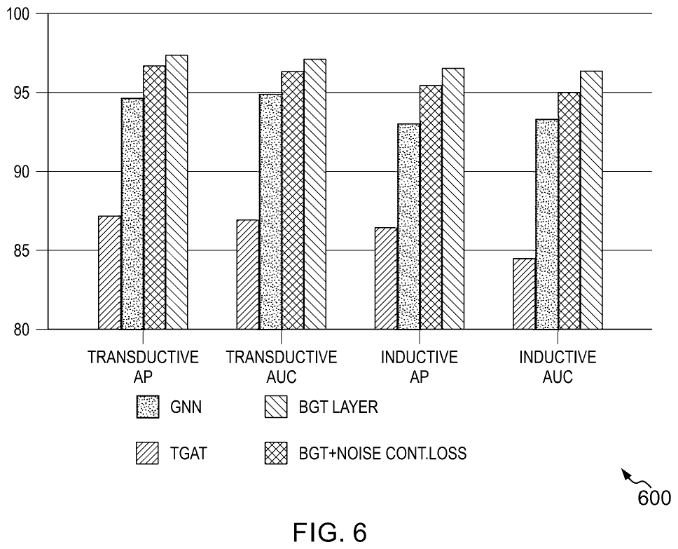

FIG. 6 illustrates the experimental results 600 of various experiments performed to determine the performance of the GNN model, in accordance with one or more embodiments of the present disclosure.

The impact of multiple components on the link prediction task for the Wikipedia dataset is shown in FIG. 6 using an ablation study. It is noted that various results shown in FIG. 6 are experimental in nature and may be associated with an error of ±5-10%. At first, for this experiment, homogeneous GNN is employed to learn the bipartite graph dynamics. Next, the temporal but homogeneous GNN, TGAT model is used to add the temporal information through aggregation leading to better performance than vanilla GNN. In the next setting, the attention in Eqn. (3) to Eqn. (6), Eqn. (9), and Eqn. (10) are realized on the GNN model using the BGT layer. In the final step, the impact of adding noise contrastive loss LNC (refer to Eqn. (11)) on top of BGT layers.

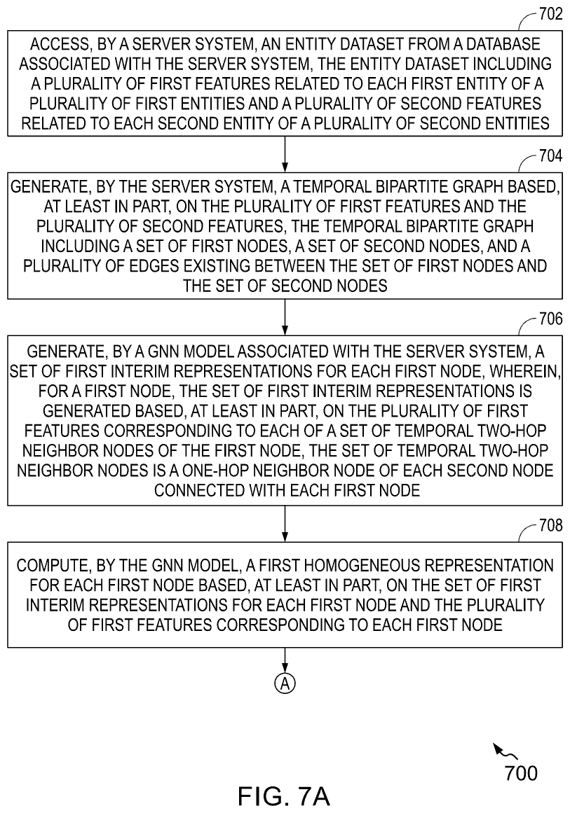

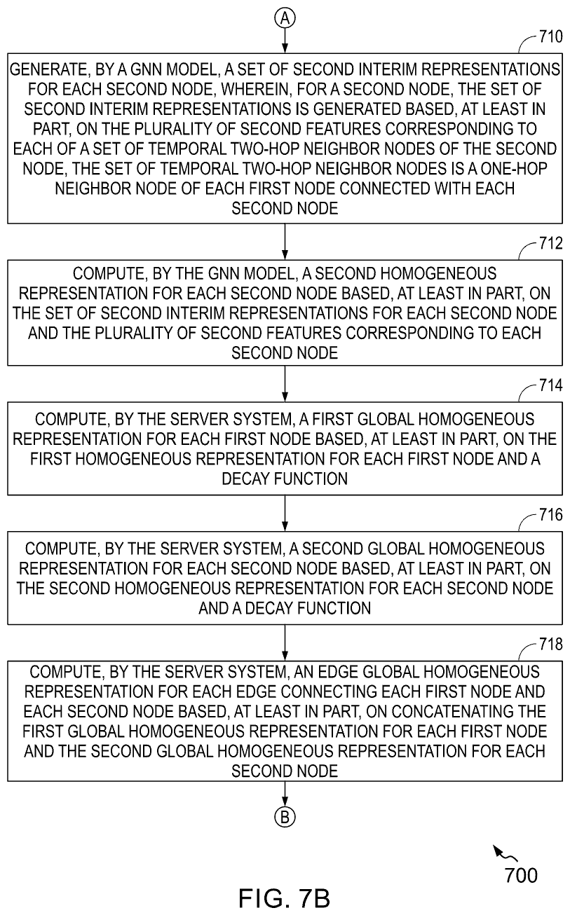

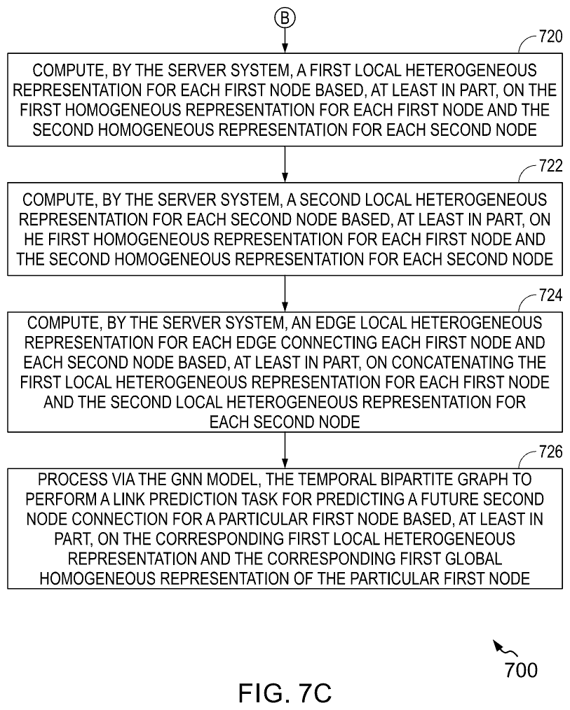

FIG. 7A, FIG. 7B, and FIG. 7C, collectively, illustrate a process flow diagram depicting a method 700 for determining representations for each node of a temporal bipartite graph and performing a link prediction task, in accordance with an embodiment of the present disclosure. The method 700 depicted in the flow diagram may be executed by, for example, the server system 200. The sequence of operations of the method 700 may not be necessarily executed in the same order as they are presented. Further, one or more operations may be grouped and performed in the form of a single step, or one operation may have several sub-steps that may be performed in parallel or in a sequential manner. Operations of the method 700, and combinations of operations in the method 700 may be implemented by, for example, hardware, firmware, a processor, circuitry, and/or a different device associated with the execution of software that includes one or more computer program instructions. The plurality of operations is depicted in the process flow of the method 700. The process flow starts at operation 702.

At 702, the method 700 includes accessing, by a server system such as the server system 200, an entity dataset such as entity dataset 216 from a database such as database 204 associated with the server system 200. The entity dataset 216 includes a plurality of first features related to each first entity of a plurality of first entities and a plurality of second features related to each second entity of a plurality of second entities. In an example, the first entity may be a user or cardholder and the second entity may be a merchant, or vice versa.

At 704, the method 700 includes generating, by the server system 200, a temporal bipartite graph based, at least in part, on the plurality of first features and the plurality of second features. The temporal bipartite graph includes a set of first nodes, a set of second nodes, and a plurality of edges existing between the set of first nodes and the set of second nodes. Herein, each first node of the set of first nodes represents an individual first entity from the plurality of first entities and is associated with corresponding plurality of first features. Further, each second node of the set of second nodes represents an individual second entity from the plurality of second entities and is associated with corresponding plurality of second features. Furthermore, each edge of the plurality of edges indicates information related to a temporal relationship between two distinct nodes connected by each edge. In an example, the first node may be a user node or cardholder node and the second node may be a merchant node, or vice versa.

At 706, the method 700 includes generating, by a GNN model 122 associated with the server system 200, a set of first interim representations for each first node. Herein, for a first node, the set of first interim representations is generated based, at least in part, on the plurality of first features corresponding to each of a set of temporal two-hop neighbor nodes of the first node. It is understood that the set of temporal two-hop neighbor nodes is a one-hop neighbor node of each second node connected with each first node. As described earlier, an attention mechanism is used to compute the set of first interim representations.

At 708, the method 700 includes computing, by the GNN model 122, a first homogeneous representation for each first node based, at least in part, on the set of first interim representations for each first node and the plurality of first features corresponding to each first node.

At 710, the method 700 includes generating, by a GNN model 122, a set of second interim representations for each second node. Herein, for a second node, the set of second interim representations is generated based, at least in part, on the plurality of second features corresponding to each of a set of temporal two-hop neighbor nodes of the second node. It is understood that the set of temporal two-hop neighbor nodes is a one-hop neighbor node of each first node connected with each second node. As described earlier, an attention mechanism is used to compute the set of second interim representations.

At 712, the method 700 includes computing, by the GNN model 122, a second homogeneous representation for each second node based, at least in part, on the set of second interim representations for each second node and the plurality of second features corresponding to each second node.

At 714, the method 700 includes computing, by the server system 200, a first global homogeneous representation for each first node based, at least in part, on the first homogeneous representation for each first node and a decay function. It is understood that instead of the decay function, an exponential function, a Recurrent Neural Network (RNN) layer, transformer layer, and the like, may be used as well.

At 716, the method 700 includes computing, by the server system 200, a second global homogeneous representation for each second node based, at least in part, on the second homogeneous representation for each second node and a decay function. It is understood that instead of the decay function, an exponential function, a Recurrent Neural Network (RNN) layer, transformer layer, and the like, may be used as well.

At 718, the method 700 includes computing, by the server system 200, an edge global homogeneous representation for each edge connecting each first node and each second node based, at least in part, on concatenating the first global homogeneous representation for each first node and the second global homogeneous representation for each second node.

At 720, the method 700 includes computing, by the server system 200, a first local heterogeneous representation for each first node based, at least in part, on the first homogeneous representation for each first node and the second homogeneous representation for each second node. As described earlier, an attention mechanism is used to compute the first local heterogeneous representation.

At 722, the method 700 includes computing, by the server system 200, a second local heterogeneous representation for each second node based, at least in part, on the first homogeneous representation for each first node and the second homogeneous representation for each second node. As described earlier, an attention mechanism is used to compute the second local heterogeneous representation.

At 724, the method 700 includes computing, by the server system 200, an edge local heterogeneous representation for each edge connecting each first node and each second node based, at least in part, on concatenating the first local heterogeneous representation for each first node and the second local heterogeneous representation for each second node.

At 726, the method 700 includes processing via the GNN model 122, the temporal bipartite graph to perform a link prediction task for predicting a future second node connection for a particular first node based, at least in part, on the corresponding first local heterogeneous representation and the corresponding first global homogeneous representation of the particular first node. To achieve this, a classifier such as an MLP layer may be used to perform the desired downstream task such as the link prediction task. It is understood that the link prediction task can be done for a future first node connection for a particular second node for which a link or edge has to be predicted.

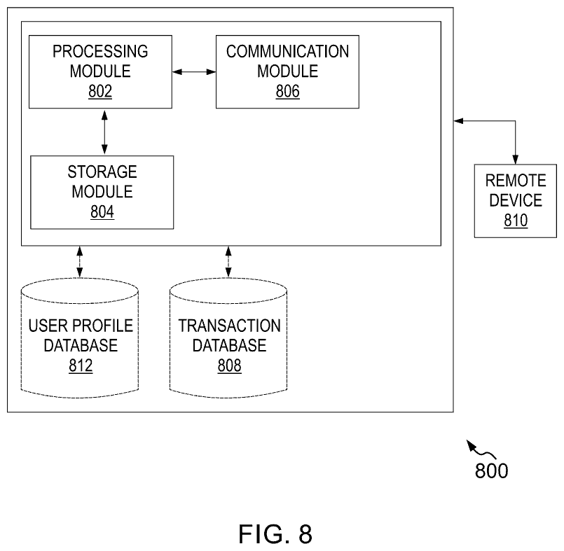

FIG. 8 illustrates a simplified block diagram of the acquirer server 800, in accordance with an embodiment of the present disclosure. The acquirer server 800 is an example of the acquirer server 108 of FIG. 1. The acquirer server 800 is associated with an acquirer bank/acquirer, in which a merchant may have an account, which provides a payment card. The acquirer server 800 includes a processing module 802 operatively coupled to a storage module 804 and a communication module 806. The components of the acquirer server 800 provided herein may not be exhaustive and the acquirer server 800 may include more or fewer components than those depicted in FIG. 8. Further, two or more components may be embodied in one single component, and/or one component may be configured using multiple sub-components to achieve the desired functionalities. Some components of the acquirer server 800 may be configured using hardware elements, software elements, firmware elements, and/or a combination thereof.

The storage module 804 is configured to store machine-executable instructions to be accessed by the processing module 802. Additionally, the storage module 804 stores information related to, the contact information of the merchant, bank account number, availability of funds in the account, payment card details, transaction details, and/or the like. Further, the storage module 804 is configured to store payment transactions.

In one embodiment, the acquirer server 800 is configured to store profile data (e.g., an account balance, a credit line, details of the plurality of merchants 106, account identification information, and a payment card number) in a transaction database 808. The details of the plurality of cardholders 104 may include, but are not limited to, name, age, gender, physical attributes, location, registered contact number, family information, alternate contact number, registered e-mail address, etc.

The processing module 802 is configured to communicate with one or more remote devices such as a remote device 810 using the communication module 806 over a network such as the network 116 of FIG. 1. The examples of the remote device 810 include the server system 102, the payment server 114, the issuer server 110, or other computing systems of the acquirer server 800, and the like. The communication module 806 is capable of facilitating such operative communication with the remote devices and cloud servers using Application Program Interface (API) calls. The communication module 806 is configured to receive a payment transaction request performed by the plurality of cardholders 104 via the network 116. The processing module 802 receives payment card information, a payment transaction amount, cardholder information, and merchant information from the remote device 810 (i.e., the payment server 114). The acquirer server 800 includes a user profile database 812 and the transaction database 808 for storing transaction data. The user profile database 812 may include information of the merchants 106. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular user, transaction location information, external data sources, and other internal data to evaluate each transaction.

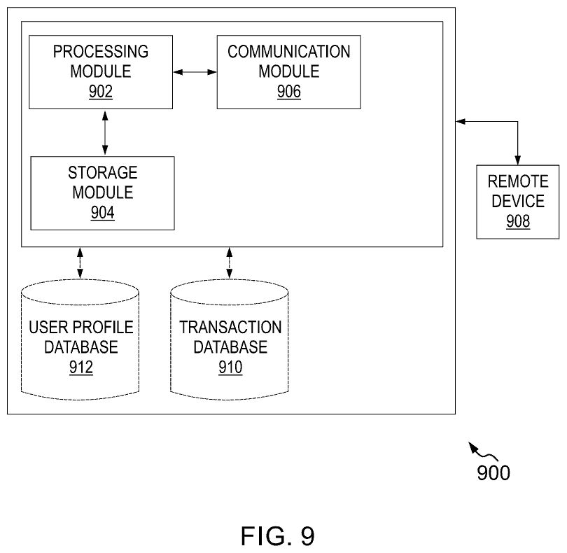

FIG. 9 illustrates a simplified block diagram of an issuer server 900, in accordance with an embodiment of the present disclosure. The issuer server 900 is an example of the issuer server 110 of FIG. 1. The issuer server 900 is associated with an issuer bank/issuer, in which an account holder (e.g., the plurality of cardholders 104(1)-104(N)) may have an account, which provides a payment card (e.g., the payment cards 118(1)-118(N)). The issuer server 900 includes a processing module 902 operatively coupled to a storage module 904 and a communication module 906. The components of the issuer server 900 provided herein may not be exhaustive and the issuer server 900 may include more or fewer components than those depicted in FIG. 9. Further, two or more components may be embodied in one single component, and/or one component may be configured using multiple sub-components to achieve the desired functionalities. Some components of the issuer server 900 may be configured using hardware elements, software elements, firmware elements, and/or a combination thereof.

The storage module 904 is configured to store machine-executable instructions to be accessed by the processing module 902. Additionally, the storage module 904 stores information related to, the contact information of the cardholders (e.g., the plurality of cardholders 104(1)-104(N)), a bank account number, availability of funds in the account, payment card details, transaction details, payment account details, and/or the like. Further, the storage module 904 is configured to store payment transactions.

In one embodiment, the issuer server 900 is configured to store profile data (e.g., an account balance, a credit line, details of the cardholders, account identification information, payment card number, etc.) in a database. The details of the cardholders may include, but are not limited to, name, age, gender, physical attributes, location, registered contact number, family information, alternate contact number, registered e-mail address, or the like of the cardholders, etc.

The processing module 902 is configured to communicate with one or more remote devices such as a remote device 908 using the communication module 906 over a network such as the network 116 of FIG. 1. Examples of the remote device 908 include the server system 200, the payment server 114, the acquirer server 108 or other computing systems of the issuer server 900. The communication module 906 is capable of facilitating such operative communication with the remote devices and cloud servers using API calls. The communication module 906 is configured to receive a payment transaction request performed by an account holder (e.g., the cardholder 104(1)) via the network 116. The processing module 902 receives payment card information, a payment transaction amount, customer information, and merchant information from the remote device 908 (e.g., the payment server 114). The issuer server 900 includes a transaction database 910 for storing transaction data. The transaction data may include, but is not limited to, transaction attributes, such as transaction amount, source of funds such as bank or credit cards, transaction channel used for loading funds such as POS terminal or ATM machine, transaction velocity features such as count and transaction amount sent in the past x days to a particular account holder, transaction location information, external data sources, and other internal data to evaluate each transaction. The issuer server 900 includes a user profile database 912 storing user profiles associated with the plurality of account holders.

The user profile data may include an account balance, a credit line, details of the account holders, account identification information, payment card number, or the like. The details of the account holders (e.g., the plurality of cardholders 104(1)-104(N)) may include, but are not limited to, name, age, gender, physical attributes, location, registered contact number, family information, alternate contact number, registered e-mail address, or the like of the plurality of cardholders 104.

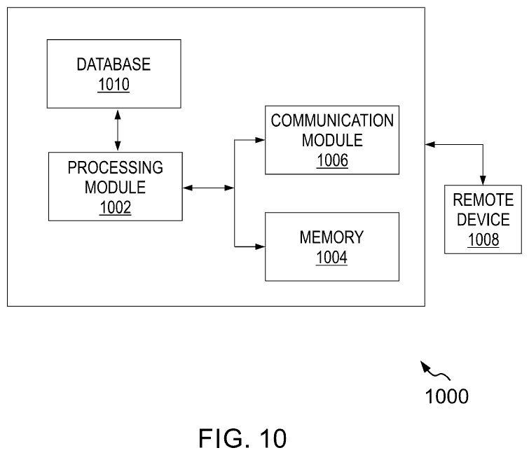

FIG. 10 illustrates a simplified block diagram of the payment server 1000, in accordance with an embodiment of the present disclosure. The payment server 1000 is an example of the payment server 114 of FIG. 1. The payment server 1000 and the server system 200 may use the payment network 112 as a payment interchange network. Examples of payment interchange networks include, but are not limited to, Mastercard® payment system interchange network.

The payment server 1000 includes a processing module 1002 configured to extract programming instructions from a memory 1004 to provide various features of the present disclosure. The components of the payment server 1000 provided herein may not be exhaustive and the payment server 1000 may include more or fewer components than that depicted in FIG. 10. Further, two or more components may be embodied in one single component, and/or one component may be configured using multiple sub-components to achieve the desired functionalities. Some components of the payment server 1000 may be configured using hardware elements, software elements, firmware elements, and/or a combination thereof.

Via a communication module 1006, the processing module 1002 receives a request from a remote device 1008, such as the issuer server 110, the acquirer server 108, or the server system 102. The request may be a request for conducting the payment transaction. The communication may be achieved through API calls, without loss of generality. The payment server 1000 includes a database 1010. The database 1010 also includes transaction processing data such as issuer ID, country code, acquirer ID, and Merchant Identifier (MID), among others.

When the payment server 1000 receives a payment transaction request from the acquirer server 108 or a payment terminal (e.g., IoT device), the payment server 1000 may route the payment transaction request to an issuer server (e.g., the issuer server 110). The database 1010 stores transaction identifiers for identifying transaction details, such as transaction amount, IoT device details, acquirer account information, transaction records, merchant account information, and the like.

In one example embodiment, the acquirer server 108 is configured to send an authorization request message to the payment server 1000. The authorization request message includes, but is not limited to, the payment transaction request.

The processing module 1002 further sends the payment transaction request to the issuer server 110 for facilitating the payment transactions from the remote device 1008. The processing module 1002 is further configured to notify the remote device 1008 of the transaction status in the form of an authorization response message via the communication module 1006. The authorization response message includes, but is not limited to, a payment transaction response received from the issuer server 110. Alternatively, in one embodiment, the processing module 1002 is configured to send an authorization response message for declining the payment transaction request, via the communication module 1006, to the acquirer server 108. In one embodiment, the processing module 1002 executes similar operations performed by the server system 200, however, for the sake of brevity, these operations are not explained herein.

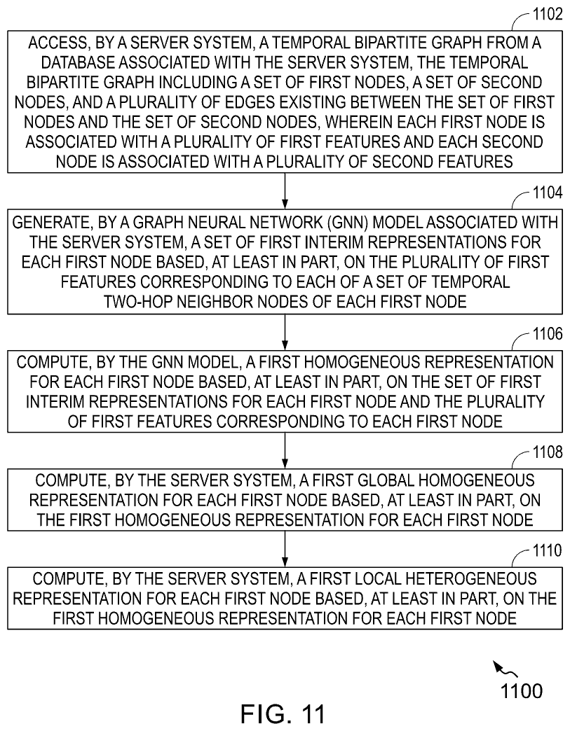

FIG. 11 illustrates a process flow diagram depicting a method 1100 for determining representations for a first node of a temporal bipartite graph, in accordance with an embodiment of the present disclosure. The method 1100 depicted in the flow diagram may be executed by, for example, the server system 200. The sequence of operations of the method 1100 may not be necessarily executed in the same order as they are presented. Further, one or more operations may be grouped and performed in the form of a single step, or one operation may have several sub-steps that may be performed in parallel or in a sequential manner. Operations of the method 1100, and combinations of operations in the method 1100 may be implemented by, for example, hardware, firmware, a processor, circuitry, and/or a different device associated with the execution of software that includes one or more computer program instructions. The plurality of operations is depicted in the process flow of the method 1100. The process flow starts at operation 1102.

At 1102, the method 1100 includes accessing, by a server system such as the server system 200, a temporal bipartite graph from a database such as database 204 associated with the server system. The temporal bipartite graph may include a set of first nodes, a set of second nodes, and a plurality of edges existing between the set of first nodes and the set of second nodes. Herein, each first node is associated with a plurality of first features and each second node is associated with a plurality of second features. In an example, the first node may be a user node or cardholder node and the second node may be a merchant node, or vice versa.

At 1104, the method 1100 includes generating, by a Graph Neural Network (GNN) model such as GNN model 122 associated with the server system 200, a set of first interim representations for each first node based, at least in part, on the plurality of first features corresponding to each of a set of temporal two-hop neighbor nodes of each first node.

At 1106, the method 1100 includes computing, by the GNN model 122, a first homogeneous representation for each first node based, at least in part, on the set of first interim representations for each first node and the plurality of first features corresponding to each first node.

At 1108, the method 1100 includes computing, by the server system 200, a first global homogeneous representation for each first node based, at least in part, on the first homogeneous representation for each first node.

At 1110, the method 1100 includes computing, by the server system 200, a first local heterogeneous representation for each first node based, at least in part, on the first homogeneous representation for each first node.

The disclosed method with reference to FIG. 7A, FIG. 7B, FIG. 7C, and FIG. 11 or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web (WWW), an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application Specific Integrated Circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause the processor or the computer to perform one or more operations. A computer-readable medium storing, embodying, or encoded with a computer program, or similar language, may be embodied as a tangible data storage device storing one or more software programs that are configured to cause the processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media. Examples of non-transitory computer-readable media include magnetic storage media (such as floppy disks, magnetic tapes, hard disk drives, etc.), optical magnetic storage media (e.g. magneto-optical disks), Compact Disc Read-Only Memory (CD-ROM), Compact Disc Recordable (CD-R), compact disc rewritable (CD-R/W), Digital Versatile Disc (DVD), BLU-RAY® Disc (BD), and semiconductor memories (such as mask ROM, programmable ROM (PROM), (erasable PROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method comprising:
accessing, by a server system, a temporal bipartite graph from a database associated with the server system, the temporal bipartite graph comprising a set of first nodes, a set of second nodes, and a plurality of edges existing between the set of first nodes and the set of second nodes, wherein each first node is associated with a plurality of first features and each second node is associated with a plurality of second features;
generating, by a Graph Neural Network (GNN) model associated with the server system, a set of first interim representations for each first node based, at least in part, on the plurality of first features corresponding to each of a set of temporal two-hop neighbor nodes of each first node;
computing, by the GNN model, a first homogeneous representation for each first node based, at least in part, on the set of first interim representations for each first node and the plurality of first features corresponding to each first node;
computing, by the server system, a first global homogeneous representation for each first node based, at least in part, on the first homogeneous representation for each first node; and
computing, by the server system, a first local heterogeneous representation for each first node based, at least in part, on the first homogeneous representation for each first node.

2. The computer-implemented method as claimed in claim 1, wherein computing the first local heterogeneous representation comprises:
generating, by the GNN model, a set of second interim representations for each second node based, at least in part, on the plurality of second features corresponding to each of a set of temporal two-hop neighbor nodes of each second node;
computing, by the GNN model, the second homogeneous representation for each second node based, at least in part, on the set of second interim representations for each second node and the plurality of second features corresponding to each second node; and
determining, by the server system, the first local heterogeneous representation for each first node based, at least in part, on the first homogeneous representation for each first node and a second homogeneous representation for each second node.

3. The computer-implemented method as claimed in claim 2, further comprising:
computing, by the server system, a second local heterogeneous representation for each second node based, at least in part, on the first homogeneous representation for each first node and the second homogeneous representation for each second node.

4. The computer-implemented method as claimed in claim 3, further comprising:
computing, by the server system, an edge local heterogeneous representation for each edge connecting each first node and each second node based, at least in part, on concatenating the first local heterogeneous representation for each first node and the second local heterogeneous representation for each second node.

5. The computer-implemented method as claimed in claim 2, further comprising:
computing, by the server system, a second global homogeneous representation for each second node based, at least in part, on the second homogeneous representation for each second node.

6. The computer-implemented method as claimed in claim 5, further comprising:
computing, by the server system, an edge global homogeneous representation for each edge connecting each first node and each second node based, at least in part, on concatenating the first global homogeneous representation for each first node and the second global homogeneous representation for each second node.

7. The computer-implemented method as claimed in claim 1, wherein accessing the temporal bipartite graph comprises:
accessing, by the server system, an entity dataset from the database associated with the server system, the entity dataset comprising the plurality of first features related to each first entity of a plurality of first entities and the plurality of second features related to each second entity of a plurality of second entities; and
generating and storing, by the server system, the temporal bipartite graph based, at least in part, on the plurality of first features and the plurality of second features,
wherein each first node of the set of first nodes represents an individual first entity from the plurality of first entities and is associated with the corresponding plurality of first features, and each second node of the set of second nodes represents an individual second entity from the plurality of second entities and is associated with the corresponding plurality of second features,
wherein each edge of the plurality of edges indicates information related to a temporal relationship between two distinct nodes connected by each edge.

8. The computer-implemented method as claimed in claim 7, wherein the plurality of first entities comprises one of a plurality of cardholders or a plurality of merchants, and the plurality of second entities comprises one of the plurality of merchants or the plurality of cardholders, respectively.

9. The computer-implemented method as claimed in claim 8, wherein the server system is a payment server associated with a payment network.

10. The computer-implemented method as claimed in claim 1, further comprising:
receiving, by the server system, a task request for performing a downstream task for a particular first node in the temporal bipartite graph; and
generating, by a classifier model associated with the server system, a prediction for the downstream task based, at least in part, on the corresponding first local heterogeneous representation and the corresponding first global homogeneous representation of the particular first node.

11. A server system, comprising:
a communication interface;
a memory comprising executable instructions; and
a processor communicably coupled to the communication interface and the memory, the processor configured to cause the server system to at least:
access a temporal bipartite graph from a database associated with the server system, the temporal bipartite graph comprising a set of first nodes, a set of second nodes, and a plurality of edges existing between the set of first nodes and the set of second nodes, wherein each first node is associated with a plurality of first features and each second node is associated with a plurality of second features;
generate, by a Graph Neural Network (GNN) model associated with the server system, a set of first interim representations for each first node based, at least in part, on the plurality of first features corresponding to each of a set of temporal two-hop neighbor nodes of each first node;
compute, by the GNN model, a first homogeneous representation for each first node based, at least in part, on the set of first interim representations for each first node and the plurality of first features corresponding to each first node;
compute a first global homogeneous representation for each first node based, at least in part, on the first homogeneous representation for each first node; and
compute a first local heterogeneous representation for each first node based, at least in part, on the first homogeneous representation for each first node.

12. The server system as claimed in claim 11, wherein to compute the first local heterogeneous representation, the server system is further caused, at least in part, to:
generate, by the GNN model, a set of second interim representations for each second node based, at least in part, on the plurality of second features corresponding to each of a set of temporal two-hop neighbor nodes of each second node;
compute, by the GNN model, the second homogeneous representation for each second node based, at least in part, on the set of second interim representations for each second node and the plurality of second features corresponding to each second node; and
determine the first local heterogeneous representation for each first node based, at least in part, on the first homogeneous representation for each first node and a second homogeneous representation for each second node.

13. The server system as claimed in claim 12, wherein the server system is further caused, at least in part, to:
compute a second local heterogeneous representation for each second node based, at least in part, on the first homogeneous representation for each first node and the second homogeneous representation for each second node.

14. The server system as claimed in claim 13, wherein the server system is further caused, at least in part, to:
compute an edge local heterogeneous representation for each edge connecting each first node and each second node based, at least in part, on concatenating the first local heterogeneous representation for each first node and the second local heterogeneous representation for each second node.

15. The server system as claimed in claim 12, wherein the server system is further caused, at least in part, to:
compute a second global homogeneous representation for each second node based, at least in part, on the second homogeneous representation for each second node.

16. The server system as claimed in claim 15, wherein the server system is further caused, at least in part, to:
compute an edge global homogeneous representation for each edge connecting each first node and each second node based, at least in part, on concatenating the first global homogeneous representation for each first node and the second global homogeneous representation for each second node.

17. The server system as claimed in claim 11, wherein to access the temporal bipartite graph, the server system is further caused, at least in part, to:
access an entity dataset from the database associated with the server system, the entity dataset comprising the plurality of first features related to each first entity of a plurality of first entities and the plurality of second features related to each second entity of a plurality of second entities; and
generate and store the temporal bipartite graph based, at least in part, on the plurality of first features and the plurality of second features,
wherein each first node of the set of first nodes represents an individual first entity from the plurality of first entities and is associated with the corresponding plurality of first features, and each second node of the set of second nodes represents an individual second entity from the plurality of second entities and is associated with the corresponding plurality of second features,
wherein each edge of the plurality of edges indicates information related to a temporal relationship between two distinct nodes connected by each edge.

18. The server system as claimed in claim 17, wherein the plurality of first entities comprises one of a plurality of cardholders or a plurality of merchants, and the plurality of second entities comprises one of the plurality of merchants or the plurality of cardholders, respectively.

19. The server system as claimed in claim 11, wherein the server system is further caused, at least in part, to:
receive a task request for performing a downstream task for a particular first node in the temporal bipartite graph; and
generate, by a classifier model associated with the server system, a prediction for the downstream task based, at least in part, on the corresponding first local heterogeneous representation and the corresponding first global homogeneous representation of the particular first node.

20. A non-transitory computer-readable storage medium comprising computer-executable instructions that, when executed by at least a processor of a server system, cause the server system to perform a method comprising:
accessing a temporal bipartite graph from a database associated with the server system, the temporal bipartite graph comprising a set of first nodes, a set of second nodes, and a plurality of edges existing between the set of first nodes and the set of second nodes, wherein each first node is associated with a plurality of first features and each second node is associated with a plurality of second features;
generating, by a Graph Neural Network (GNN) model associated with the server system, a set of first interim representations for each first node based, at least in part, on the plurality of first features corresponding to each of a set of temporal two-hop neighbor nodes of each first node;
computing, by the GNN model, a first homogeneous representation for each first node based, at least in part, on the set of first interim representations for each first node and the plurality of first features corresponding to each first node;
computing a first global homogeneous representation for each first node based, at least in part, on the first homogeneous representation for each first node; and
computing a first local heterogeneous representation for each first node based, at least in part, on the first homogeneous representation for each first node.
